(19) United States
(12) Patent Application Publication
(10) Pub. No.: US 2013/0246097 A1
(43) Pub. Date: Sep. 19, 2013

(54) Medical Information Systems and Medical Data Processing Methods

(71) Applicants: Howard M. Kenney, Spokane, WA (US); Jeffrey B. Butler, Spokane, WA (US); Gary L. Craig, Colbert, WA (US); Sean P. LaSalle, Spokane, WA (US); Eric C. Mueller, Spokane, WA (US); Karen M. Ferguson, Colbert, WA (US)

(72) Inventors: Howard M. Kenney, Spokane, WA (US); Jeffrey B. Butler, Spokane, WA (US); Gary L. Craig, Colbert, WA (US); Sean P. LaSalle, Spokane, WA (US); Eric C. Mueller, Spokane, WA (US); Karen M. Ferguson, Colbert, WA (US)

(21) Appl. No.: 13/606,880

(22) Filed: Sep. 7, 2012

Related U.S. Application Data
(63) Continuation-in-part of application No. 12/726,281, filed on Mar. 17, 2010, now Pat. No. 8,458,610.
(60) Provisional application No. 61/533,115, filed on Sep. 9, 2011.

(51) Int. Cl. G06Q 50/24; G06Q 10/10

(52) U.S. Cl. CPC G06Q 50/24; G06Q 10/10
USPC 705/3

(57) ABSTRACT

Medical information systems and medical data processing methods are described. According to one aspect, a medical information system includes a communications interface which is configured to receive patient treatment data from a plurality of medical providers and which regards medical treatment provided by the medical providers with respect to a plurality of patients; and storage circuitry storing the patient treatment data for the plurality of patients of the plurality of the medical providers in a database.

### RELATED PATENT DATA

This application is a continuation-in-part of and claims priority to U.S. patent application Ser. No. 12/726,281, which was filed on Mar. 17, 2010, entitled “Medical Information Generation and Recordation Methods and Apparatus,” and this application also claims priority to a U.S. Provisional Patent Application Ser. No. 61/533,115, filed Sep. 9, 2011, entitled “Medical Information Systems And Medical Data Processing Methods”, the disclosures of which are incorporated herein by reference.

### TECHNICAL FIELD

This disclosure relates to medical information systems and medical data processing methods.

### BACKGROUND OF THE DISCLOSURE

The use of computing devices is ubiquitous in the workplace to implement numerous tasks in numerous different applications. For example, in the medical field, physician notes regarding patients were traditionally kept in a series of papers within a chart. The treating physician could review the patient's chart before examining the patient to gain information regarding the patient's previous health history. In addition, the physician may add new notes resulting from a recent examination. These charts may be stored electronically for ease of use, management, and recollection.

At least some aspects of the disclosure are directed to methods and apparatus for generating and recording medical information pertinent to a patient's health. In some aspects, the medical information may be efficiently used by medical personnel for treatment of the patient. Other aspects are disclosed as is apparent from the following detailed description.

### BRIEF DESCRIPTION OF THE DRAWINGS

Exemplary embodiments of the disclosure are described below with reference to the following accompanying drawings.

FIG. 1 is a functional block diagram of a computing system according to one embodiment.

FIG. 2 is a functional block diagram of a client device according to one embodiment.

FIG. 3 is a graphical user interface used by medical personnel to input and review information regarding a patient's health according to one embodiment.

FIGS. 3A-3C depict different user interfaces which may be used to input information regarding patient outcomes according to one embodiment.

FIG. 4 is a graphical representation of trend data according to one embodiment.

FIG. 5 is a graphical user interface which may be used by medical personnel to select a value of general health of a patient according to one embodiment.

FIG. 6 is a map illustrating how FIGS. 6A and 6B are to be assembled. Once assembled, FIGS. 6A and 6B are an example template which may be used to provide information to a medical agency according to one embodiment.

FIG. 7 is a map illustrating how FIGS. 7A and 7B are to be assembled. Once assembled, FIGS. 7A and 7B are an example chart note of the patient's examination according to one embodiment.

FIG. 8 is a flow chart illustrating an example method performed by the computing system according to one embodiment.

FIG. 9 is a functional block diagram of a medical information system according to one embodiment.

FIG. 10 is a graphical representation of trend data including patient treatment data according to one embodiment.

FIG. 11 is a flow chart of a method of a patient check-in procedure according to one embodiment.

FIG. 12 is a flow chart of an examination of a patient by a physician according to one embodiment.

FIG. 13 is a flow chart of processing of patient treatment data according to one embodiment.

### DETAILED DESCRIPTION OF THE DISCLOSURE

This disclosure is submitted in furtherance of the constitutional purposes of the U.S. Patent Laws “to promote the progress of science and useful arts” (Article 1, Section 8).

At least some aspects of the disclosure are directed to methods, apparatus and programming to assist physicians and other medical personnel with generating and recording of data pertaining to the health of patients. In one embodiment, the generation of a plurality of different reports is facilitated. Trends of information regarding a patient's health may be tracked over time and charted in another embodiment. A graphical user interface corresponding to the human anatomy is provided in one embodiment to facilitate inputting and recording of information regarding a patient, such as information relating to joints. In another embodiment, data regarding the patient's health may be used to generate a value for an outcome measure which is indicative of a level of disease activity in a patient, and which may be used in some embodiments to evaluate past treatment and to determine appropriate treatment for the patient in the future. Other aspects and embodiments are described below.

According to one embodiment, a medical information system comprises: a communications interface which is configured to receive patient treatment data from a plurality of medical providers and which regards medical treatment provided by the medical providers with respect to a plurality of patients; and storage circuitry storing the patient treatment data for the plurality of patients of the plurality of the medical providers in a database.

According to an additional embodiment, a medical data processing method comprises: receiving patient treatment data regarding medical treatment provided by a plurality of medical providers to a plurality of patients; de-identifying the patient treatment data comprising removing identification information from the patient treatment data which identifies the patients and providing anonymous patient treatment data void of the identification information; and permitting access of medical supply entities of medical products which are used during the medical treatment of the patients to the anonymous patient treatment data.

According to yet another embodiment, a medical data processing method comprises: using processing circuitry, accessing patient treatment data regarding medical treatment provided by a plurality of medical providers to a plurality of patients having a common medical condition; and using processing circuitry, processing the patient treatment data to identify previously unknown information with respect to treatment of the common medical condition.

Another embodiment provides a medical data processing method comprising: using processing circuitry, accessing patient treatment data regarding medical treatment provided by a plurality of medical providers to a plurality of patients having a common medical condition; and using the patient treatment data to demonstrate efficacy of the medical treatment provided by the medical providers to the patients to treat the common medical condition.

Yet another embodiment provides a medical data processing method comprising: using processing circuitry, accessing information regarding a patient having a medical condition which is to be treated, wherein the accessed information includes information regarding a plurality of outcomes for the patient which correspond to the medical condition; and using processing circuitry and the information regarding the plurality of outcomes, identifying an appropriate treatment for the patient using information regarding the previous use of the treatment upon a plurality of other patients with the medical condition and whose outcomes correspond to the outcomes of the patient.

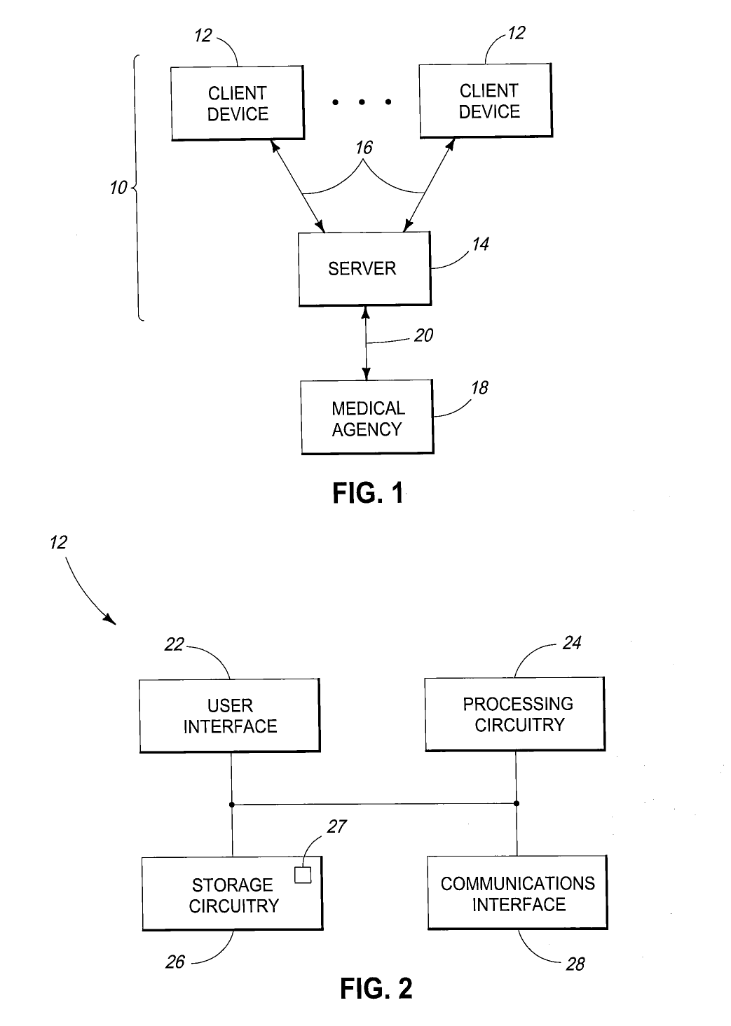

Referring to FIG. 1, a computing system 10 which is configured to implement some aspects of the disclosure is shown according to one example embodiment. The illustrated computing system 10 includes one or more client devices 12, a server 14 and a communications media 16 configured to implement communications intermediate client devices 12 and server 14. The computing system 10 may be implemented within a physician's office and be secured in one embodiment.

Server 16 is configured to additionally communicate with other devices or systems which may be external of the computing system 10 (e.g., a medical agency 18 described below) via a communications media 20. Server 14 may communicate via communications media 20 with the external devices. Communications media 20 may be the Internet in one example implementation. Other configurations of computing system 10 are possible. For example, server 14 may be omitted in some arrangements and aspects of the disclosure may be implemented using a client device 12.

Client devices 12 may be configured as personal or portable notebook computers in example implementations. Medical personnel (e.g., physicians, physician assistants, nurses, etc.) may communicate with patients during examinations and use the client devices 12 to input, generate and record information pertaining to the health of the patients. The inputted information may result from patient's answers to diagnosis questions and/or results of examinations and tests in some examples Client devices 12 may communicate the information to server 14 via communications media 16 which may be implemented as a local area network in one example (e.g., utilized within a physician's office). The information regarding the health of the patients may be provided into an electronic record corresponding to the patient and communicated to server 14 for storage, for example within a database. The electronic records may be reviewed at later moments in time and supplemented with additional information as the patient is treated by the medical personnel.

Server 14 may include a database configured to store the electronic records including information regarding the patient's health for later retrieval. Furthermore, server 14 may use the information regarding a patient's health to generate additional information regarding the patient's health. The generated information may include charts, graphs, outcome measures and other information regarding the patient and which may also be provided within the electronic record of the patient. In some embodiments, individual client devices 12 may generate additional information regarding the patient's health and include the data within an electronic record for the patient which is communicated to the server 14.

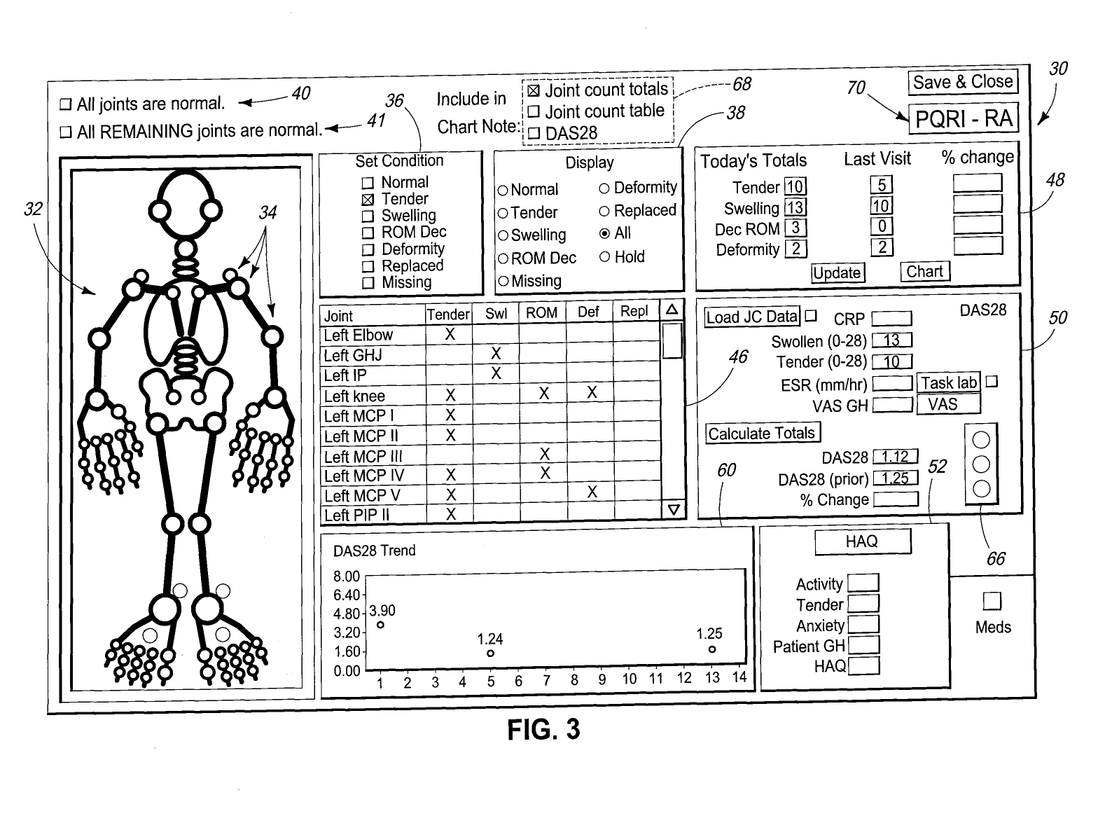

Referring to FIG. 2, details of one example embodiment of a client device 12 in the form of a personal or notebook computer is shown. In the depicted example, the client device 10 includes a user interface 22, processing circuitry 24, storage circuitry 26 and a communications interface 28. Other configurations of client device 10 are possible including more, less and/or alternative components. Although not described in detail, server 14 may also be configured to include the components depicted in FIG. 2 in one example embodiment.

User interface 22 is configured to interact with a user including conveying data to a user (e.g., displaying visual images for observation by the user) as well as receiving inputs from the user, for example via a keyboard and point device (e.g., mouse). User interface 22 is configured as graphical user interface (GUI) in one example embodiment.

In one embodiment, processing circuitry 24 is arranged to process data, control data access and storage, process data to generate reports, issue commands, and control other desired operations. Processing circuitry 24 may comprise circuitry configured to implement desired programming provided by appropriate computer-readable storage media in at least one embodiment. For example, the processing circuitry 24 may be implemented as one or more processor(s) and/or other structure configured to execute executable instructions including, for example, software and/or firmware instructions. Other exemplary embodiments of processing circuitry 24 include hardware logic, PGA, FPGA, ASIC, state machines, and/or other structures alone or in combination with one or more processor(s). These examples of processing circuitry 24 are for illustration and other configurations are possible.

Storage circuitry 26 is configured to store programming such as executable code or instructions (e.g., software and/or firmware), electronic data, databases, image data, electronic reports or other digital information and may include computer-readable storage media. At least some embodiments or aspects described herein may be implemented using programming stored within one or more computer-readable storage medium of storage circuitry 26 and configured to control appropriate processing circuitry 24.

The computer-readable storage medium may be embodied in one or more articles of manufacture 27 which can contain, store, or maintain programming, data and/or digital information for use by or in connection with an instruction execution system including processing circuitry 24 in the exemplary embodiment. For example, exemplary computer-readable storage media may include any one of physical media such as electronic, magnetic, optical, electromagnetic, infrared or semiconductor media. Some more specific examples of computer-readable storage media include, but are not limited to, a portable magnetic computer diskette, such as a floppy diskette, a zip disk, a hard drive, random access memory, read only memory, flash memory, cache memory, and/or other configurations capable of storing programming, data, or other digital information.

Communications interface 28 is arranged to implement communications of client device 12 with respect to external devices (such as server 14). For example, communications interface 28 may be arranged to communicate information bi-directionally with respect to external devices. Communications interface 28 may be implemented as a network interface card (NIC), serial or parallel connection, USB port, Firewire interface, flash memory interface, or any other suitable arrangement for implementing communications with respect to external devices.

As mentioned above, client devices 12 may be used by medical personnel during patient examinations to generate and record information pertinent to the health of the patient. At least some aspects of the disclosure are directed to methods, apparatus and programming which enable medical personnel to efficiently input information ascertained from examinations for recordation, storage, subsequent retrieval, and generation of additional information regarding the patient's health in some examples. Some aspects of the disclosure are directed to facilitating generation of patient reports using the stored information regarding the patients' health. The information regarding the patient's health may be used to develop trend information indicative of the patients' health over time. At least some aspects are directed to generation of the patient reports into formats which may be easily retrievable and utilized by other entities, such as medical agencies 18 discussed above. Furthermore, the information regarding the patient's health may be used to provide an outcome measure which may indicate a level of activity of a disease in a patient and which may indicate how the patient has responded to treatment and may be used to determine appropriate courses of treatment in the future.

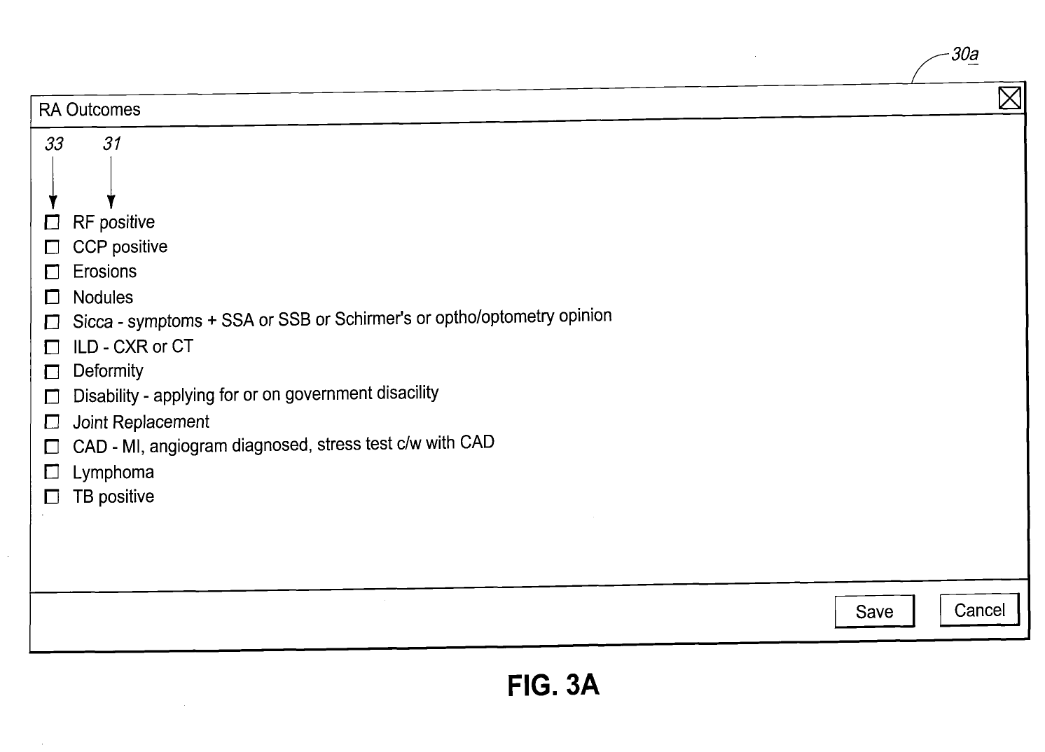

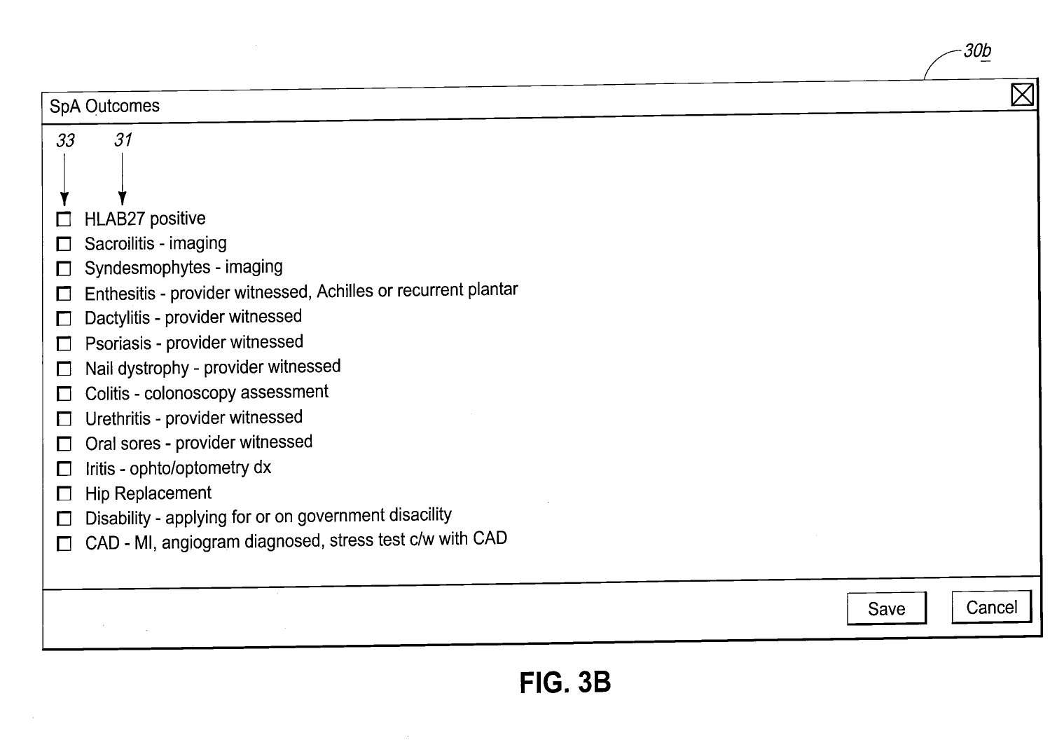

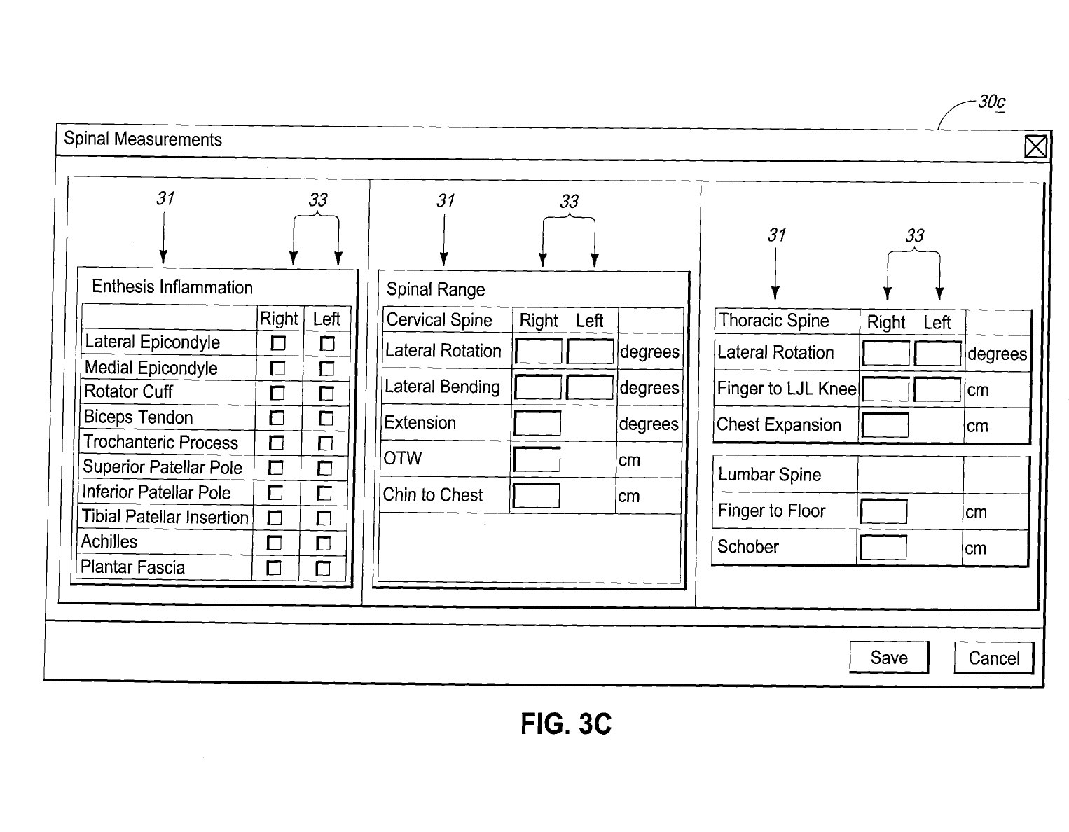

Referring to FIG. 3, one embodiment of a graphical user interface 30 which may be displayed by a client device 12 is shown. The example depicted graphical user interface 30 may be used by medical personnel during examination of patients to input information and display previous information regarding previous examinations, for example, including trend data comprising information regarding a patient's health over time. The example embodiment of FIG. 3 is intended to assist rheumatologists in treating patients with rheumatoid arthritis. Other embodiments may be directed to assist other types of medical personnel with other types of medical treatment and may include other graphical user interfaces which include graphical representations of other parts of the human anatomy in some examples.

In the depicted example, the graphical user interface 30 includes a representation 32 of the human anatomy. The graphical representation 32 includes a plurality of selectable portions 34 which correspond to different portions of the human anatomy and which may be selected by user inputs of a user (e.g., medical personnel). For example, the user inputs may be provided by a user using an interactive pointing device (e.g., mouse) resulting from the examination of the patient and which interact with selectable portions 34 of the human anatomy. In the depicted example directed towards treatment of rheumatoid arthritis, the selectable portions 34 correspond to different joints of the human anatomy. In a more specific example discussed below, the user may select one or more joint of the human anatomy and associate one or more condition with the selected joint(s).

The illustrated embodiment of the graphical user interface 30 includes a set condition window 36 which includes a plurality of conditions (e.g., normal, tender, swelling, range of motion limited, deformity, replaced, missing) which correspond to a plurality of different conditions of the human joints. During an examination of the patient, the medical personnel may use representation 32 and window 36 to inventory conditions of the patient's joints. For example, the medical personnel may select the “tender” option of the different conditions, and thereafter select the respective portions (e.g., joints) 34 which the patient indicates are currently tender or are otherwise painful. This may be repeated for the other conditions until each of the joints are labeled with an appropriate condition corresponding to the state of the patient's joints during the examination. Boxes 40, 41 are also provided to assist the medical personnel with quickly indicating that all joints are normal, or all remaining joints are normal in the depicted arrangement.

In one embodiment, data pertaining to the health of the patient resulting from the examination may be displayed in the graphical representation 32. In one embodiment, the different joints of the graphical representation 32 having different conditions may be labeled using different colors which respectively correspond to the different conditions. In one embodiment, the text of the individual conditions of window 36 may also be color coded to the respective colors used to indicate the conditions of the joints in the graphical representation 32. For example, the data of the patient may be displayed by illustrating some joints in the graphical representation 32 as one color (e.g., red) corresponding to a respective condition (e.g., tender) while joints having another condition (e.g., swelling) may be displayed as second color (e.g., purple).

In addition, some joints may have a plurality of conditions associated with them during the examination and the respective joints may be individually displayed having a plurality of colors corresponding to the plurality of colors. For example, if one joint is both tender and swelled, then half of the joint may be depicted as red and the other half may be depicted as purple simultaneously indicating the plural conditions of tender and swelled individual joint.

Window 46 illustrates an example of a joint count table which includes a plurality of entries (e.g., textual listing of the joints of the body) and data for the respective entries (e.g., conditions of the respective joints for the patient). In one embodiment, the joint count table is automatically generated by the processing circuitry without further user input once the medical personnel uses the graphical representation 32 to input the conditions of the joints of the patient. Accordingly, in the described example embodiment, the medical personnel may efficiently and accurately input the conditions using the graphical representation 32 which may then be utilized to automatically generate the joint count table which may otherwise have to be created by hand. In addition, the option may exist for the medical personnel to interact directly with joint count table and to input and/or change conditions for respective ones of the joints directly using the joint count table. The generated information (e.g., the graphical representation 32 having the selected conditions/colors, joint count table, etc.) may be recorded and efficiently imported into subsequently generated reports in one embodiment.

The graphical user interface 30 may be utilized by the medical personnel to quickly change the conditions displayed by the graphical representation 32. For example, the medical personnel may select one, some or all of the different conditions to be displayed on the respective joints of the graphical representation 32. More specifically, a display window 38 is provided in the depicted example of FIG. 3 which lists the different conditions which the medical personnel can select to control the conditions which are displayed using the graphical representation 32. For example, the user may select “swelling” to have the joints which were assigned the “swelling” condition highlighted in the graphical representation 32 with the respective color. This permits the medical personnel to quickly change between the respective conditions and easily determine which joints have the respective conditions. In addition, “all” joints may also be selected where all the conditions of all the joints may be displayed in the graphical representation 32.

An additional window 48 is provided in the example of FIG. 3 which lists numerical totals of the joints having the different conditions “tender,” “swelling,” “decreased range of motion,” and “deformity.” Following the association of the different conditions with respective ones of the joints using graphical representation 32, the user may select the “update” button of window 48 to have the processing circuitry 14 generate the joint totals for the different conditions and display of the joint totals in window 48 under “today's totals.” In other embodiments, the processing circuitry 14 automatically updates the joint total information without additional user interaction as the user assigns the conditions to the respective joints.

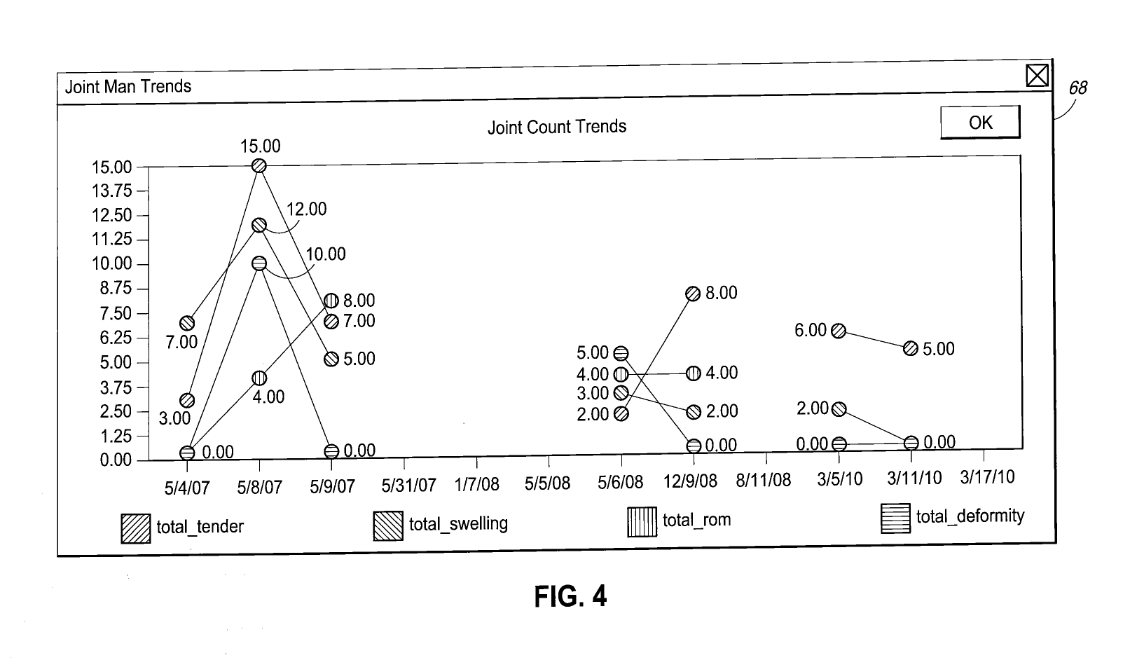

In addition, the joint totals for the different conditions from the previous visit may also be retrieved from an appropriate database and also displayed. The % change of the current totals versus the previous totals may also be displayed to provide the medical personnel with a quick indication of whether the patient's disease has improved, degraded or remained substantially the same as the previous examination. The medical personnel may also select the “chart” button to generate a chart of trend information regarding the conditions of the joints. One example of the generated chart of trend data regarding the joints is shown in FIG. 4 and described below.

The graphical user interface 30 of FIG. 3 also includes a window 50 which may include information regarding an accepted outcome measure which may be used to describe the level of activity of the disease in the patient in a standardized way, for example, for comparison with other individuals and which may be used to analyze responses of the patient to previous treatments or drugs and to guide future treatment decisions in one implementation.

In accordance with the described example pertaining to rheumatoid arthritis, one example outcome measure is DAS28. Other outcome measures may be used in other embodiments. The indexed and standardized DAS28 outcome measure uses data from a plurality of parameters including conditions of tenderness (pain) and swelling of a plurality of 28 joints of the human body, laboratory information, and a physician's evaluation of the general health of the patient in terms of an amount of disease activity present in the patient resulting from the examination and observation of the patient. The pertinent joints for calculating the DAS28 score are the shoulders, elbows, wrists, metacarpophalangeal joints, proximal interphalangeal joints and the knees in the described embodiment.

In the depicted example of the graphical representation 32, data may be provided for joints in addition to the above-mentioned joints used for the DAS28 outcome measure. Accordingly, in one embodiment, the data (e.g., assigned conditions) of only some of the joints are used to determine a value of the outcome measure for the respective patient. The assigned conditions for the joints used for the DAS28 outcome measure may be used to determine the value for the outcome measure while the data regarding the other joints may be preserved in the patient's electronic record for completeness and additional information for use by the medical personnel with respect to additional joints of the patient.

The information for the parameters is combined to provide a value for the outcome measure which is indicative of the extent of the disease activity in the individual for the day of the examination. In the described example using the DAS28 outcome measure, the generated value may of the outcome measure may be referred to as a DAS28 score.

In one embodiment, the DAS28 score is calculated according to the following formula:

DAS28=0.56*sqrt(tender28)+0.28*sqrt(swollen28)+0.70*ln(ESR)+0.014*GH

where swollen28 and tender28 are the number of swollen joints and tender joints, respectively, ESR is the Erythrocyte Sedimentation Rate in mm/hour and, GH is the patient's general health or global disease activity. The patient's general health may be measured on a visual analog scale (VAS) as determined by the physician in one embodiment.

In one embodiment, the graphical user interface 30 assists the medical personnel with generating the value of the outcome measure for the patient. More specifically, the medical personnel may select the “load JC data” button and the total numbers of swollen and tender joints as inputted by the medical personnel interfacing with the graphical representation 32 may be automatically imported into window 50. In other embodiments, the total numbers of swollen and tender joints may be automatically imported into window 50 following the indication of the joints which are swollen and tender by interaction with graphical representation 32.

The patient's CRP and ESR value may be entered by the medical personnel into window 50 if known. Furthermore, the “task lab” button may be selected to cause an automated task to be sent to an associated laboratory of the physician's office, for example, to provide the patient's ESR results.

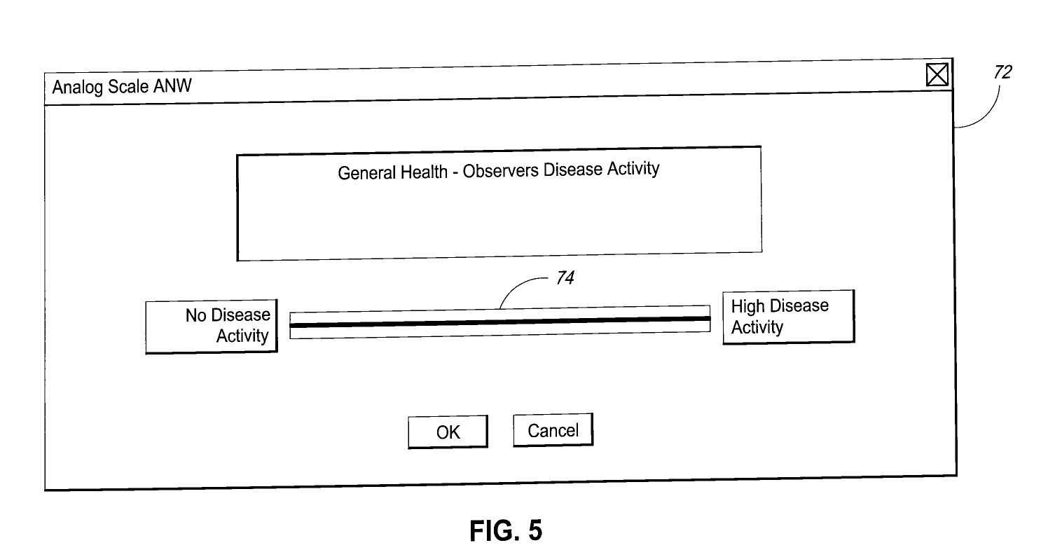

The medical personnel may also input a general health value of the patient into window 50. Alternatively, the “VAS” button may be selected which provides a window shown in FIG. 5 and the physician may use the graphical interface thereof to input a value for the general health of the patient using a visual analog scale in one embodiment.

Following inputting of the information into window 50, the medical personnel may select the “calculate totals” button to generate the DAS28 score for the patient's current visit. In addition, the DAS28 score of the previous visit of the patient may also be retrieved from a database and displayed. Furthermore, a % change value of the current DAS28 score versus the DAS28 score of the previous visit may also be displayed to efficiently provide the medical personnel with comparison information regarding evaluation of the patient's disease over time.

The example graphical user interface 30 may also include a window 66 which provides a graphical indication of scores regarding the patient. In one example, the indicators may provide an efficient way of interpreting a patient's outcome measure. The example graphical indication illustrated in FIG. 3 may provide a quick reference or interpretation of the numerical value for the outcome measure. More specifically, in one embodiment, the window 66 includes three indicators which may be selected corresponding to the patient's current DAS28 score. A plurality of ranges of DAS28 scores may be used to select which indicator is displayed. In one example, a green indicator may be displayed in window 66 for a current DAS28 score of <2.6 and which indicates that the disease is currently in remission, an orange indicator may be displayed for a DAS28 score between 2.6-5 to indicate low-medium activity and a red indicator may be displayed for DAS28 scores which are >5.1 and which indicate a relatively high disease activity. The indicators of window 66 may be used as a quick guide providing information for the current disease activity of the patient in a graphical sense without the medical personnel having to readily recall numerical data ranges for interpretation of the numerical results of the outcome measures in one embodiment. Additional or alternative indicators may be used in other embodiments.

The graphical user interface 30 includes a window 52 for entering additional data. For rheumatoid arthritis, data for measures regarding a patient's physical function scores, such as health assessment questionnaire (HAQ) scores may be entered. In a more specific embodiment, a total activity score, a total tender/pain score, a total anxiety score, a general health score (from the patient's perspective) and an overall HAQ score may be calculated. For example, questions regarding the patient's ability to perform various activities may be used to calculate an activity score (e.g., whether the patient can dress themselves, whether the patient can get into or out of bed, lift a glass of water to their mouth, walk outdoors on flat ground, wash/dry their body, bend to pick up objects from the floor, turn faucets on/off, get into/out of a car, walk two miles, and/or participate in sports). Other pertinent questions include whether or not the patient had a good night's sleep, whether they can deal with feelings of anxiety of nervousness, whether the patient can deal with feelings of depression or feeling blue, and the patient's overall assessment of pain. The responses to the questions may be provided according to predetermined responses (e.g., without any difficulty, with some difficulty, with much difficulty, or unable to accomplish) which may be weighted and/or quantified and used to calculate numerical scores for activity, tender, anxiety, patient's general health and HAQ.

The graphical user interface 30 also includes a window 60 configured to display trend data regarding a history of values of an outcome measure (e.g., DAS28 scores) for the respective patient at a plurality of moments in time in the depicted example embodiment. Window 60 includes a graph including a plurality of markers corresponding to time along the x-axis and a scale of possible DAS28 score values along the y-axis. The DAS28 scores for the patient may be graphed versus different moments in time in the example window 60. Window 60 provides the medical personnel with a history of information regarding the DAS28 scores which may be quickly and efficiently reviewed and utilized for example to determine whether current treatment (e.g., medications) for the patient are appropriate or if modifications should be made to the patient's treatment.

As described in the example embodiment of FIG. 3, the graphical user interface 30 may assist the treating physician or other medical personnel with identifying the different conditions for the patient during the examination and provide a simple and efficient interface for inputting the conditions and other data regarding the patient into the computing system 10. The inputted information may be imported and further displayed in other alternative formats. For example, the data (e.g., list of joints and respective conditions) may be provided as raw data, graphically displayed in the graphical representation of the human anatomy, and included in a joint count table which includes a plurality of entries (e.g., different joints) and data pertinent to the patient for the entries (e.g., conditions of the joints of the patient) in some examples. The data may be used to calculate values of outcome measures described above to indicate the activity level of the disease in the patient, to determine whether the patient is responding to treatment, and/or which may also be used to determine appropriate courses of future treatment in some examples.

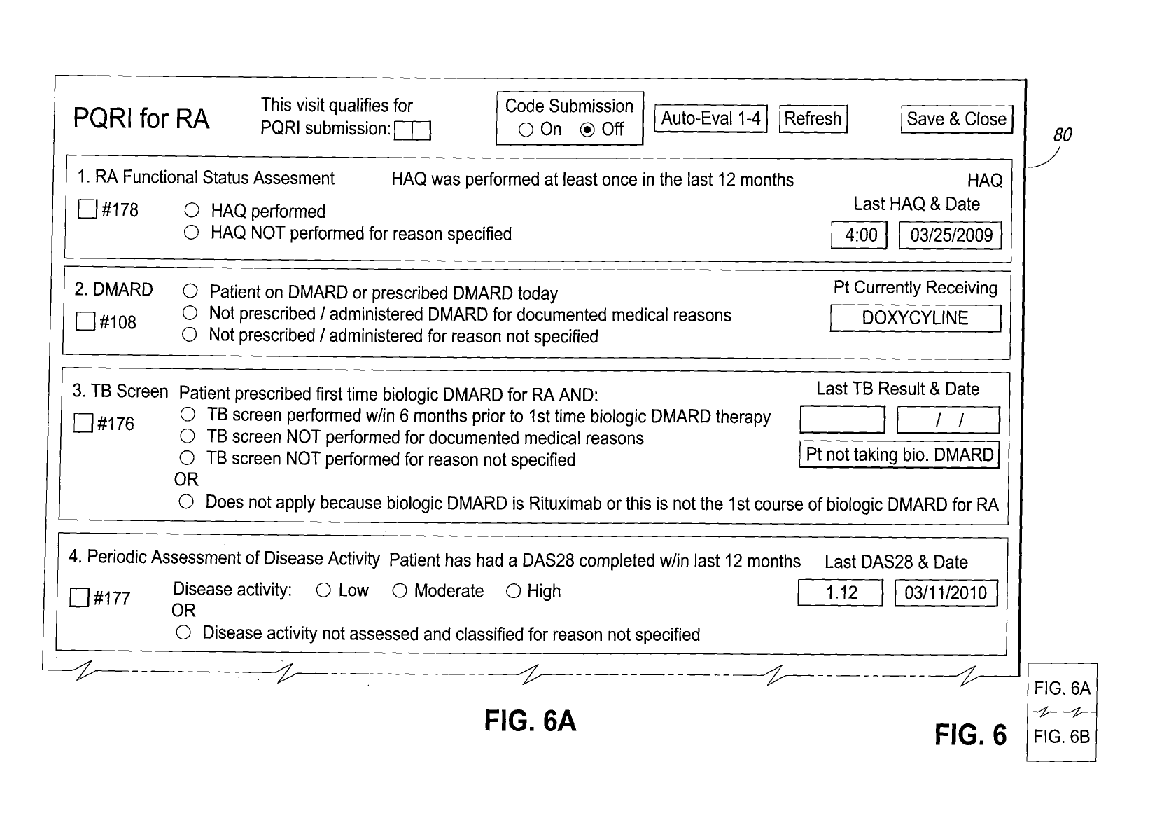

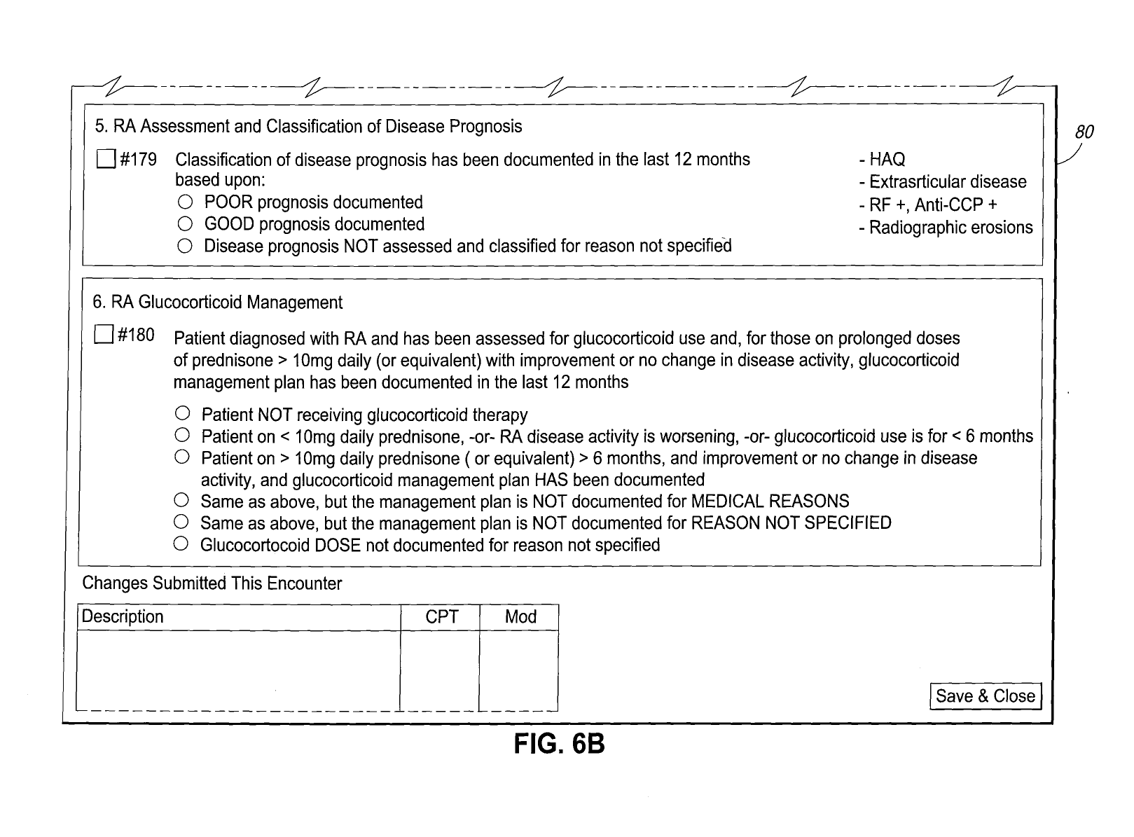

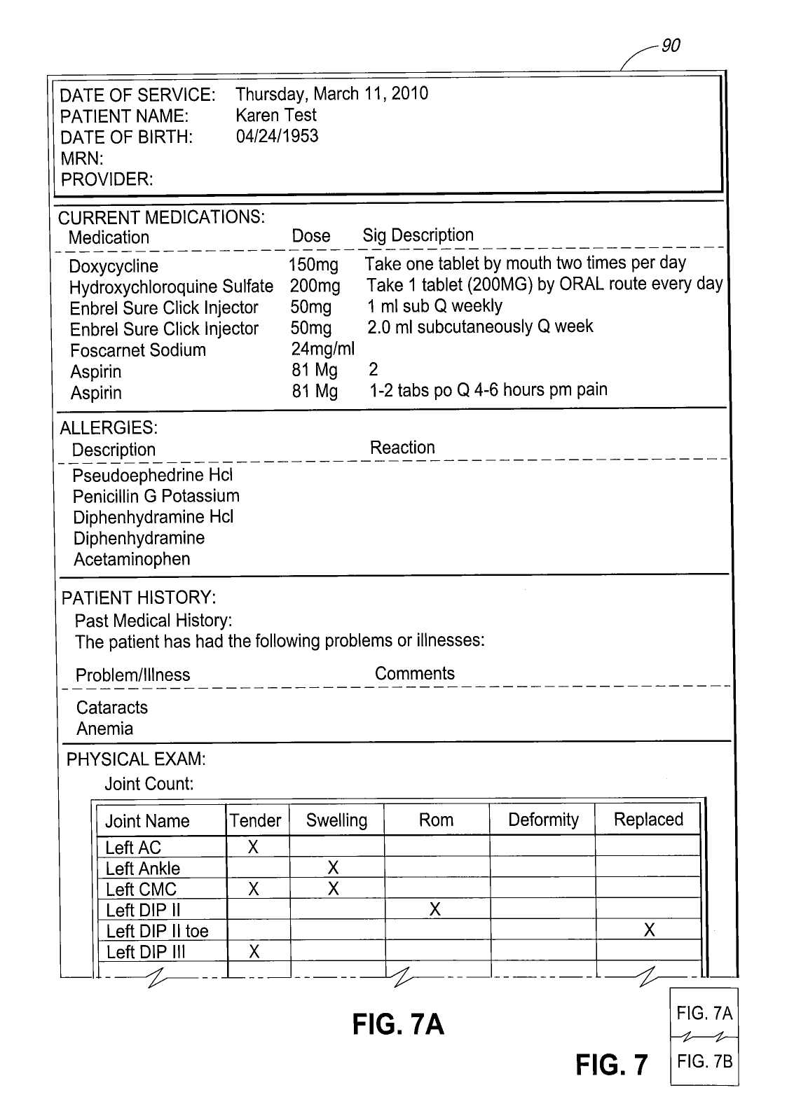

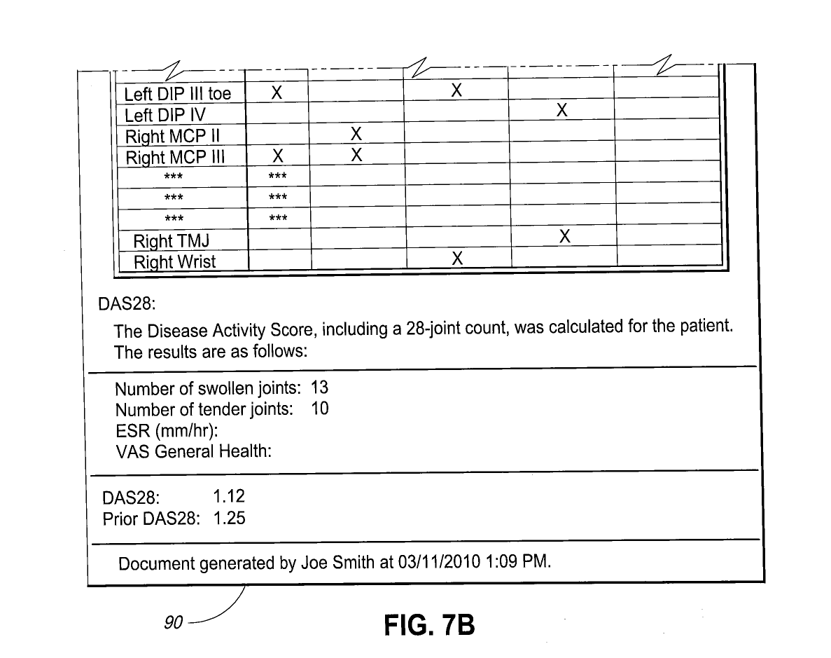

Graphical user interface 30 may also be used by the medical personnel to efficiently generate various reports regarding the patient's current examination and/or information regarding a plurality of examinations. The information inputted via the graphical user interface 30 may be used to generate additional reports for submissions to a medical agency 18 as described with respect to FIG. 6 and a chart note as described with respect to FIG. 7 in two illustrative examples.

The illustrated graphical user interface 30 includes a plurality of selectable boxes 68 which enable the medical personnel to specify the contents of subsequently generated reports. In the illustrated example, the medical personnel may select one or more of “joint count totals,” “joint count table” and “DAS28” to have respective joint count total information from window 48, the joint count table from window 46 and outcome measure (e.g., DAS28) information from window 50 included in subsequently generated reports.

In one embodiment, graphical user interface 30 may also be used by the medical personnel to generate additional information and reports regarding patient information. In one example, the PQRI-RA link 70 may be selected which directs the medical personnel to another window, for example as discussed below with respect to FIG. 6, which assists the medical personnel with the generation of reports for submission to a medical agency 18, such as Medicare, for incentives for complying with quality measures of treatment and/or payment of the services for treatment.

The content of the graphical user interface 30 resulting from the patient visit may be stored as an electronic record for the patient, for example, within a database of the computing system 10. The electronic record may include the graphical representation 32 of the graphical user interface 30 shown in FIG. 3 with the pertinent data for the individual patient (e.g., respective joints displayed with the respective selected conditions). The stored information of the electronic record may additionally include all of the other displayed information of graphical user interface 30. The stored information may be used to generate different types of reports regarding the patient's health for various uses and which may also be stored as part of the electronic record of the patient using the database of the computing system 10.

For example, as discussed above, the inputted data may be used to generate a value of an outcome measure (e.g., DAS28 score) pertaining to the patient's health and which may be used by medical personnel for analysis of past treatment, for guidance in future treatment decisions and to describe activity of the disease of the patient. Trends of the patient's health may be provided to assist with determinations of whether the patient has responded favorably or not to certain medications and decisions for future treatment may be made using the recorded information in one embodiment. The information may be provided in a single comprehensive template (e.g., as shown in FIG. 3) in one embodiment, and the medical personnel may quickly review information regarding the inventory of joint conditions, past information, trend information, outcome measure information (e.g., DAS28 score) and HAQ information in the described example. The described examples of information which may be included are illustrative and the templates, reports and/or interfaces may be altered to accommodate additional and/or alternative information, for example pertaining to other medical specialties or treatments. Accordingly, the electronic report for a patient may include the graphical representation 32 of the anatomy with the different conditions indicated for the respective joints, associated tables, outcome measure data, reports, and trend data. The electronic reports may include any other data pertinent to the health of the patient.

Referring to FIGS. 3A-3C, a plurality of user interfaces 30a-30c are depicted which may be displayed during intake or examination of a patient being treated initially or during a follow-up visit. User interfaces 30a-30c are helpful to assist medical personnel with inputting patient information, including outcomes, various measurements of physical range of motion, and inflammation which correspond to the patient. In one embodiment, the different interfaces 30a-30c may be selected by the medical personnel during the patient examination, for example using buttons which may be added to an appropriate interface, such as interface 30 of FIG. 3.

In the illustrated examples, interface 30a may be selected and used by the medical personnel to input information regarding a list 31 of outcomes of a patient being treated for rheumatoid arthritis. For each of the outcomes in the list 31 in FIG. 3A which are present for the patient, the corresponding fields or boxes 33 for the respective outcomes may be checked. FIG. 3B illustrates one example interface 30b which may be used for inputting of outcomes of a list 31 for treatment of patients with Ankylosing spondylitis and the interface 30c of FIG. 3C may be used for recording physical range of motion for spinal measurements and Enthesis inflammation in boxes 33 of the lists 31. In one embodiment, inflammation and outcome data may be represented as a Boolean value (e.g., displayed as a check mark or lack thereof) indicating the presence of the related physical state. Range of motion values may be represented as an integer or floating point number in example embodiments. The process of determining if a patient has a particular outcome depends on the outcome itself, but in general, tools such as blood tests, radiographs, and visual assessments may be utilized. The inputted outcomes may be used to indicate whether a disease is present, a level of activity of a disease, and describing a state of a patient. As discussed below, the generated outcomes may also be used for additional purposes including determining appropriate treatment for the patient as well as storage and analysis for future treatment of other patients.

Referring to FIG. 4, a window 68 is illustrated according to one embodiment which is displayed responsive to medical personnel selecting the “chart” button in window 48 of FIG. 3. The window 68 depicts trend information in the form of joint counts for the example application to arthritis treatment described herein. The joint information entered via graphical user interface 30 of FIG. 3 at different moments in time may be stored and graphed for efficient review of the patient's information over a period of time. In the illustrated example, the patient's information for total numbers of joints having the following different conditions are displayed: tender (painful), swelling, range of motion (ROM) decrease and deformity over a period of time from May 2007 to March 2010 in the illustrated example. The depicted example graph conveys information regarding the patient's health over a relatively significant period of time to the medical personnel in a straightforward and efficient manner.

Referring to FIG. 5, an example window 72 is displayed and which is generated responsive to a user selecting the VAS button of window 50 of graphical user interface 30 of FIG. 3. The illustrated window 72 assists the medical personnel with entering data regarding the patient's general health (GH) or global disease activity measured on a visual analog scale (VAS) in the depicted embodiment. The medical personnel may interact with a linear scale 74 of the window 72 to select a value for the general health of the patient based upon the examination. In the illustrated example, the scale extends from one extreme of “No Disease Activity” to another extreme of “High Disease Activity.” A range of possible scores which may be selected are from 0 corresponding to “No Disease Activity” and extending to 10 corresponding to “High Disease Activity” in but one example. Once the medical personnel has selected an appropriate value on the linear scale 74, the user may press OK and the entered value will be imported into the window 50 of the graphical user interface 30 and used for DAS28 calculations in the described example. The entered data may also be stored for later retrieval. In other embodiments, the value of the general health may be entered in any appropriate method, for example by typing the score into the window 50.

Referring to FIGS. 6A-6B, an example template 80 which may be displayed following selection of the PQRI-RA link 70 of the graphical user interface 30 is shown. The template 80 may be used to prepare submissions for qualifying with incentives and/or reimbursement for services from a medical agency 18, such as such a Medicare. In one specific example, the depicted template is for preparing Physician Quality Reporting Initiative-Rheumatoid Arthritis (PQRI-RA) submissions. Appropriate information regarding the patient's health already inputted into the computing system 10, for example the HAQ score and DAS28 score calculated via the graphical user interface 30 of FIG. 3, may be automatically imported from a database of computing system 10 into the template 80 without requiring manual entry by the medical personnel. Additional questions of the template 80 may be answered by medical personnel and the results may be saved. In one embodiment, the information of the completed template 80 may be reformatted into a submission for acceptance by the medical agency 18 and sent to the appropriate medical agency 18 (e.g., via a secured network connection) for incentives and/or reimbursement of costs and services incurred by the physician's office in treating the patient.

Referring to FIGS. 7A and 7B, an exemplary report regarding the patient's visit can be generated in the form of a chart note 90. During the examination, the medical personnel may input responses to a series of questions using their respective client device 12 and the responses may be displayed in the example chart note 90. The answers, such as medications, allergies, and other data regarding patient history may be provided on the chart note 90 as shown. Furthermore, the data results of the physical examination, for example the data of the joint count information of the table 46 of FIG. 3 entered via interaction with the human anatomy representation 32 or via other appropriate means can also be automatically imported into the chart note 90 from the database of the computing system 10 without manual entry by the medical personnel. The chart note 90 may be placed in the electronic medical record of the patient, printed for submission to other appropriate entities or physicians, and stored using the database of the computing system 10.

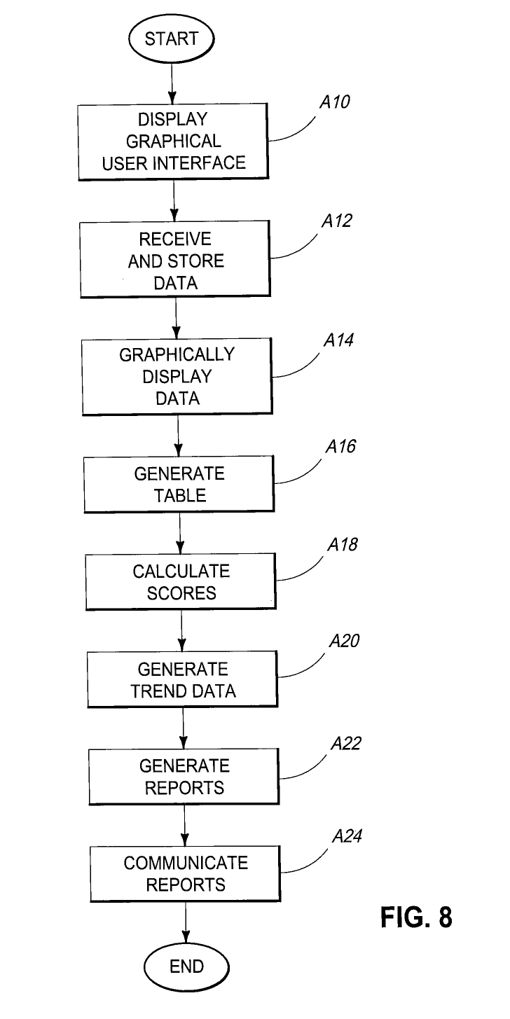

Referring to FIG. 8, a method which may be implemented by computing system 10 is shown according to one embodiment. Other methods are possible including more, less or alternative acts in other embodiments.

At an act A10, a graphical user interface may be displayed on a client device which includes a representation of the human anatomy in one embodiment.

At an act A12, an appropriate user may input information regarding a patient examination via the graphical user interface. For example, the inputted information regarding the patient's health may include a plurality of conditions for a plurality of joints of the patient in but one example pertaining to treatment of rheumatoid arthritis. The inputted data may be updated into an electronic record of the patient and stored. Previously-stored information and other data, such as laboratory data, may be accessed at act A12 and perhaps combined with the newly entered data.

At an act A14, the graphical user interface may graphically represent the information regarding the patient's health. For example, different colors may be associated with different joints to indicate the different conditions of the patient's joints at the time of the examination.

At an act A16, one or more table of the information regarding the patient's health may be generated (and perhaps displayed using the graphical user interface).

At an act A18, scores or values, for example, for an outcome measure for the patient may be calculated using the information regarding the patient's health (and perhaps displayed using the graphical user interface).

At an act A20, the information for the current visit may also be combined with other stored data to provide trend data, for example joint count trends, DAS28 trends, etc. (and perhaps displayed using the graphical user interface).

At an act A22, appropriate reports may be generated using the information pertaining to the patient's health (and perhaps displayed using the graphical user interface). For example, chart notes, submissions to other entities or any other desired reports including the information pertinent to the health of the patient may be generated and displayed.

At an act A24, the generated reports containing the information pertinent to the patient's health may be stored and communicated to appropriate recipients (e.g., medical agency 18, referring physicians, etc.).

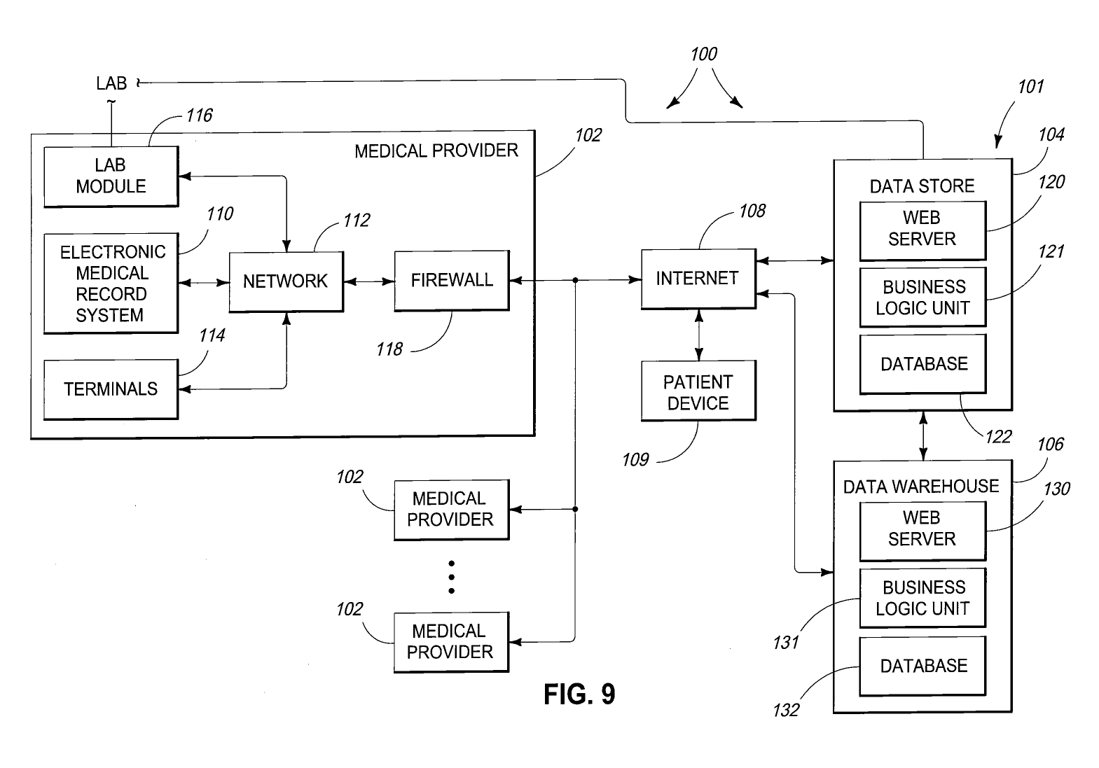

The above-disclosure recites systems and methods for assisting physicians with treating patients and managing data resulting from the treatment. For example, the jointman interface of FIG. 3 is tailored to assist rheumatologists with the treatment of patients with rheumatoid arthritis. Referring to FIG. 9, a medical information system 100 is shown which is arranged to also assist physicians with the treatment of patients according to one embodiment. The example embodiment of FIG. 9 includes a centralized management system 101 which communicates with and manages patient treatment data generated during treatment of patients by a plurality of medical providers 102. The medical providers 102 may individually correspond to a physician's office, clinic, hospital, or other association of physicians. Furthermore, the medical providers 102 may also be specialists who are professionals with respect to treating a common disease or medical condition (e.g., rheumatoid arthritis) in one implementation. As discussed further below in one arrangement of medical information system 100, a professional medical organization (PMO) entity may direct some operations of management system 101 and medical providers 102 may be participants of the PMO. Management system 101 may also be managed as a private or public business entity.

The medical information system 100 facilitates entry and management of patient treatment data (also referred to as patient data) obtained during patient encounters with the medical providers 102. In one embodiment, the medical information system 100 may analyze the patient treatment data, for example, to assist with identification of disease trends, treatment efficacy and perhaps identifying new medical practices or procedures for future treatment as discussed in further detail below. Example patient treatment data may include data regarding the patient (e.g., symptoms, conditions, other ailments, diseases, treatment, drugs used, etc.) as well as costs associated with treatment. The system 100 may generate reports for submission to appropriate agencies regarding the treatment of individual patients and groups of patients.

In some embodiments described below, the patient treatment data may also be de-identified (e.g., all information which identifies the patients may be removed), and thereafter the aggregate patient data from the plural medical providers 102 may be analyzed, including subjected to statistical analysis and data mined, and reports may be generated regarding the results for various uses including developing new treatment methods for various diseases, tracking of costs, treatment efficacy, justifying treatment, etc. The analysis and generated reports may be pre-defined, customized, practice-specific, provider-specific, aggregated, etc. The following discussion is tailored to rheumatology to illustrate various example embodiments of the disclosure and the medical information system 100 may be utilized in other specialties of medicine in other implementations or embodiments.

One of the medical providers 102 is shown utilizing an electronic medical record (EMR) system 110 in the depicted embodiment. System 110 may be configured similar to the hardware shown in FIG. 2 in one embodiment. An electronic medical record system 110 may be implemented from various vendors, such as NextGen Healthcare Information Systems, Inc. Others of the medical providers 102 may also utilize EMR systems, or utilize paper-based systems for managing patient records.

The electronic medical record system 110 may communicate patient treatment data to the management system 101 via the internet 108 or other communication network so data need not be entered more than once in one embodiment. Furthermore, data inputted for example while using the interface of FIG. 3, may be accessed and provided to the management system 101 in one embodiment. In other example, patient treatment data may be entered directly into the management system 101 during encounters with patients. The management system 101 may also communicate data or information to respective providers 102, for example, in electronic files to the EMR system 110 or in paper form (e.g., chart notes) for inclusion in a paper-based system. In some arrangements, the patient treatment data may be mapped between the management system 101 and EMR system 110 so the same data is provided within both systems.

Different medical providers 102 may be arranged differently and use different components. In the example of FIG. 9, the EMR system 110 of the first provider 102 may be coupled with a network 112, one or more computer terminals 114, and a lab module 116 in one embodiment. Network 112 may be a local wired and/or wireless network in one configuration and which may also implement communications with respect to devices which are external to the medical provider 102 via a firewall 118 and the Internet 108 or other communications network. Individual medical providers 102 may communicate with management system 101 using a secure Internet connection, such as a virtual private network (VPN) or via the SSL protocol, in one embodiment.

As mentioned above, medical provider 102 may include one or more computing terminal 114 which may include computers utilized by front desk personnel, check-in personnel, medical assistants, physicians, administrators and other authorized employees. In one example discussed below, patients may also utilize a terminal 114 during a check-in procedure to enter data into the EMR system 110 and/or management system 101. The EMR system 110 of the medical provider 102 and system 101 may also be configured to receive data from the Internet 108 which was entered by a patient using their own patient device 109 (e.g., computer, smartphone, etc.). Example information which may be entered includes patient identification information (e.g., name, birthdate, or other information which identifies an individual patient), payment, insurance coverage, etc. Additional terminals 114 may also be provided to receive additional medical information, for example, which may be provided via a health access card (e.g., available from the Medical Group Management Association or MGMA).

The first illustrated medical provider 102 also includes a lab module 116 which may communicate with external laboratories. The medical provider 102 may place lab orders and receive results via the lab module 116 which may be stored in EMR system 110. An appropriate messaging system (e.g., HL7) may be utilized in one embodiment to implement the communications between the lab module 116 and the laboratory.

The centralized management system 101 may associate the patient treatment data with respective patients, for example, using patient identification numbers and encounter identification numbers (corresponding to each encounter of the patient with the medical provider 102) provided by the treating medical provider 102. Lab data may also be passed from the medical provider 102 to the management system 101 or the management system 101 may receive lab data from the laboratory directly.

The illustrated management system 101 includes a data store 104 and data warehouse 106 in one embodiment. The data store 104 and data warehouse 106 exchange information with the medical providers 102 and perhaps other entities (not shown), such as medical products supply entities, government agencies, etc. Although not shown in FIG. 9, the management system 101 may also include a back-up system to provide a failover configuration for backing up the data of one or both of the data store 104 and data warehouse 106 in case of failure and to provide continuous service.

In the illustrated example embodiment, data store 104 is configured as a three tiered system which includes a web server 120, Business Logic Unit 121 and a database 122. Other configurations may be utilized. Web server 120 may be configured similar to the hardware shown in FIG. 2 in one embodiment and may be configured to implement secure communications (e.g., via a VPN or the SSL protocol) with respect to medical providers 102 and data warehouse 106. For example, patient treatment data regarding individual patients may be communicated to medical providers 102 during treatment of the patients, for example using respective web pages for the respective patients served by the web server 120. Web server 120 (and Web server 130) are configured to implement services over the Internet Protocol and FTP, HTTP or HTTPS or other desired communication protocols.

The physicians and other medical personnel may use the patient web pages to insert patient treatment data resulting from encounters with the patients. Furthermore, the patient web pages may also include templates (e.g., the interface of FIG. 3) to assist medical personnel with the entry of data resulting from a patient encounter and the entered data may be stored within the database 122 in one embodiment. The data for the respective patients may be stored with the patient number and encounter number in the database 122. In one embodiment, the data within database 122 includes information which identifies the patient and may be used to back-up patient treatment data of the medical providers 102. In one implementation, the web server 120 of data store 104 runs on Microsoft Interface Information Servers (IIS) and the database 122 runs on SQL servers (MSSS).

As mentioned above, example data provided by medical providers 102 to data store 104 include patient treatment data resulting from encounters with patients and which regard medical treatment provided by the medical providers with respect to the patients. For example, the patient treatment data may include drugs used by the patients, outcome measures indicative of the medical treatment (e.g., DAS 28 scores), joint condition data, other medical conditions of the patients, diseases or ailments of the patients, results of the examinations, and any other information pertinent to the health and medical treatment of the patients.

Business Logic Unit 121 may be configured similarly to the hardware shown in FIG. 3 in one embodiment. Business Logic Unit 121 performs manipulations and calculations upon the data to generate desired reports, searches, etc.

In one embodiment, data warehouse 106 is configured similarly to data store 104 and includes a web server 130, Business Logic Unit 131 and database 132. Database 132 includes a de-identified version of the data from the data store 104. For example, data within the data store 104 may be provided to data warehouse 106 on a periodic basis (e.g., daily). Patient identification information (e.g., name, birthdate, etc.) may be de-identified (e.g., stripped) from patient treatment data within database 122 which is transferred from the data store 104 to the data warehouse 106 providing anonymous data which still includes the patient treatment data for the patients on a patient basis but without an ability to directly identify the individual patient to which any of the anonymous data corresponds. For example, the data fields which contain patient identification data to be stripped is not copied to the database 132 of the warehouse 106 during a copy procedure from database 122.

Furthermore, business logic unit 121 may also be configured to appropriately condition the patient treatment data for processing in the data warehouse 106 in one embodiment. For example, the patient treatment data may be extracted from database 122 and transformed or converted before it is provided to data warehouse 106 to facilitate data mining or other analysis operations by the data warehouse 106. In one embodiment, a patient identifier number may remain associated with the data of a respective patient.

The business logic unit 131 of data warehouse 106 may be utilized to perform processing of the anonymous patient treatment data as well as generating reports and results of the processing. Unit 131 may be configured similar to the hardware shown in FIG. 2 in one embodiment. Example processing of the patient treatment data includes statistical analyses, specialized analysis resulting from physician input, data mining, for example, using data processing algorithms (e.g., appropriate business intelligence or knowledge discovery algorithms) and other desired processing. Generated reports may be securely provided to medical providers 102 or other entities described below using web server 130 in one embodiment and used for different purposes described below.

The processing of the patient treatment data may be used for outcome based medicine using outcome measures generated for the medical providers 102. The outcome measures may be used to provide information regarding efficacy of treatment (e.g., whether a patient's disease state is improved by a given treatment for example involving a specific drug). The outcome based medicine may be used to justify treatments of patients prescribed by the physicians as well as formulate new treatment procedures or methods for a common medical condition which may be studied using the data from the medical providers 102 treating patients with the common medical condition.

In some more specific examples, the processing of the patient treatment data may attempt to identify previously unknown information which may be beneficial to the treatment of a medical condition. For example, the processing may attempt to identify new patterns and relationships in the data, for example, which may be used for outcome based medicine in determining disease trends and treatment efficacy and perhaps identify new treatments for best practices medicine in the respective medical specialties and perform future research. Generic data mining algorithms and/or specialized searches resulting of criteria specified by data-mining experts, data-mining technicians, physicians or other medical personnel (e.g., identify all patients with rheumatology and lymphoma and their responses to different treatments) may be performed upon the anonymous patient treatment data to generate knowledge discovery reports. The anonymous patient treatment data may also be subjected to appropriate statistical analyses. The processing of the data may be practice-specific, provider-specific, region-specific and/or for the entire medical information system 100. The reports may be used to determine best medicine practices for future treatment of patients, efficacy of treatments, identify unknown trends, etc. In but one illustrative example, the data mining may identify a class of people with a certain disease who respond well to a certain type of drug or combination of drugs which may thereafter be used for future treatment.

Furthermore, the anonymous patient treatment data may also be of significant importance to medical supply entities who make medical products for the treatment of a common medical condition (e.g., rheumatoid arthritis). Example medical supply entities include manufacturers of example medical products, such as drugs, implants, etc. which are used to treat patients. The anonymous patient treatment data may be made available to the medical supply companies who can also process the data with respect to the results of their medical products with respect to treatment (e.g., efficacy of administered drugs), for research of new products, or for other purposes in one implementation. In one embodiment, the medical supply entities may provide compensation for the use of the data, for example, to the entity which operates the management system 101. Furthermore, some of the compensation received from the medical supply entities may be provided to the medical providers 102 for compensation for using their patient treatment data in one embodiment.

In one embodiment mentioned above, a professional medical organization (PMO) may operate the medical management system 101 and medical providers 102 may join the PMO as participants. The participants submit their patient treatment data to the data store 102, database 122 and data warehouse 106 for analysis and processing. In one embodiment, the management system 101 is configured to maintain the confidentiality of the patient treatment data such that a given one of the medical providers 102 may only access their own respective patient treatment data and not the data of other medical providers 102. The participants may also receive the results of the processing of their and other participants' patient treatment data to use for future treatment of patients. Participants of the PMO may also receive benefits of any reduced pricing of the medical products secured by the PMO with respect to participating medical supply entities who may or may not also process the patient treatment data.

In some implementations, the management system 101 may be utilized to develop protocols and pathways for the different specialties of the medical providers 102. An operator of management system 101 may identify and direct research to be performed upon patient treatment data. The management system 101 provides a system and methodologies for clean and accurate data entry so that generated reports are valid and useful for setting the protocols and pathways for future medical treatment.

In one embodiment described above, information including patient treatment data and files may be mapped or shared between the data store 104 and the EMR systems 110 of the respective medical providers 102. In one implementation, the medical information system 100 includes a connector which may be a modular and scalable health information exchange which maps or cross-populates patient treatment data between database 122 and EMR system 110, for example, as encrypted data using the VPN between the medical providers 102 and the management system 101 across the internet 108. The connector may reside as triggers, scripts, stored procedures, or other executable code and network adaptor configurations within the EMR system 110, data store 104, or network 112 in one embodiment and which listen for connections and calls to stored procedures to map the patient treatment data between the databases.

Data store 104 may query the EMR system 110 for patient and encounter identification information, store patient treatment data (e.g., joint conditions in an example rheumatoid arthritis implementation) and generate chart notes which may be communicated back to the providers 102 for storage in EMR system 110 or as pdf files for paper-based systems in one embodiment. In addition, the connector may be utilized to update patient treatment data (e.g., joint conditions) from the data store 104 to the tables of the EMR system 110. For example, a medical record for a given patient may be accessed by a treating physician from the data store 104 during a patient encounter for data entry and the entered patient treatment data as a result of the encounter may be propagated to the respective medical provider 102 visited by the patient. In one embodiment, individual medical records of patients are accessed and updated at the data store 104 by the physicians during a patient encounter and the entered or modified data may be replicated to the medical records of the patients in the respective medical providers 102 which treat the respective patients such that the medical providers 102 have complete medical records (e.g., patient charts) for their respective patients and chart notes generated by the data store 104 for encounters of respective patients.

The connector may request a list of patient encounters which may be provided by the EMR systems 110. Furthermore, during patient visits, physicians may request patient information from the data store 104 and data store 104 may serve appropriate web pages for the respective patients being treated as mentioned above and which may include previously stored patient treatment data. The web pages may include templates which assist the physicians or other medical personnel with entry of patient treatment data, for example, HAQ scores, Review of Systems (ROS) values, infusion data, etc.

Accordingly, in one embodiment, the entered data initially resides within the data store 104. The physician may enter updated patient treatment data during an encounter with the patient. Following the entry of the patient treatment data, the connector may map the newly entered data (e.g., updated patient treatment data) and respective encounter identifiers from the data store 104 to the EMR system 110 and which entry may be confirmed by the EMR system 110. If the data entered via a template such as FIG. 3 is saved, then a chart note may be generated by data store 104 and communicated to EMR system 110 or medical provider 102 directly if an EMR system 110 is not used. In addition, patient treatment data such as joint conditions, VAS scores, and medications the patients is taking as entered via the patient's web page may also be sent to EMR system 110. Data store 104 may also request lab results (e.g., SED rates and CRP data) for a patient and may continue to search for the lab results from the EMR system 110 until received in one embodiment. The data store 104 may generate a chart note which includes the lab results and may be communicated to EMR system 110 in one embodiment.

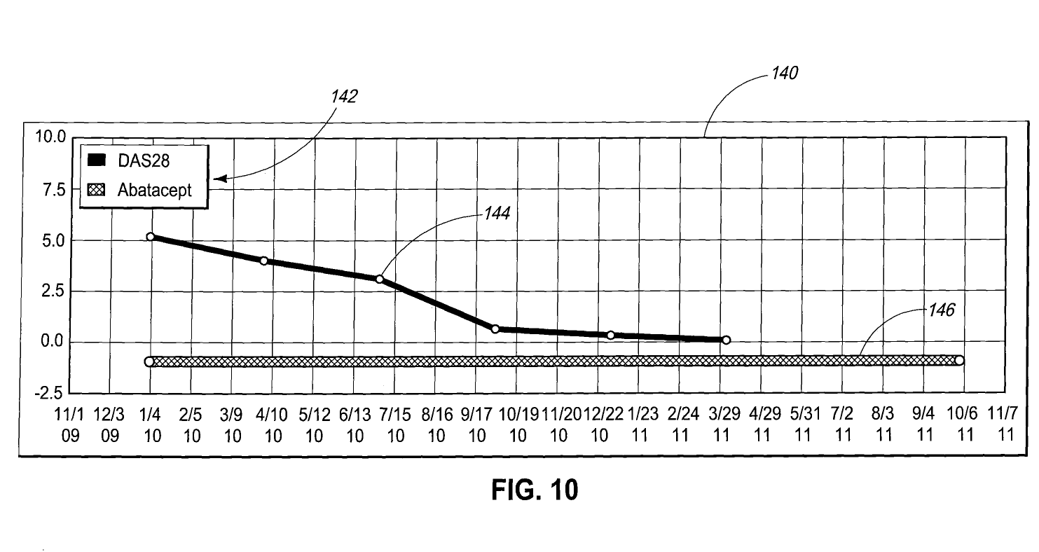

Referring to FIG. 10, trends of patient treatment data are shown in one example graph 140. In the illustrated example embodiment, the graph 140 includes one or more outcome measures for the patient and medications taken by the patient. In the example of FIG. 10, the graph 140 includes an index 142 which shows the particular outcome measure and drug being graphed with respect to time. A line 144 may be used to connect the outcome measure values ascertained at different moments in time (e.g., during different patient encounters) to show a trend of the disease for the particular patient over time. In addition, the graph 140 also includes a line 146 which shows a medication taken by the patient with respect to time.

The example graph 140 presents a relationship of outcome measures and medications in a straightforward graphical representation which may be used by physicians to make future decisions regarding the patient's treatment. The graph 140 may be used for outcome based medicine or medical treatment and shows relationships of diseases activity (e.g., high activity to remission) with drugs as trends over time during actual treatment of patients and which may be used to make future best practices decisions, justification of treatment, etc. Other outcome measures and other medications may also be graphed if appropriate.

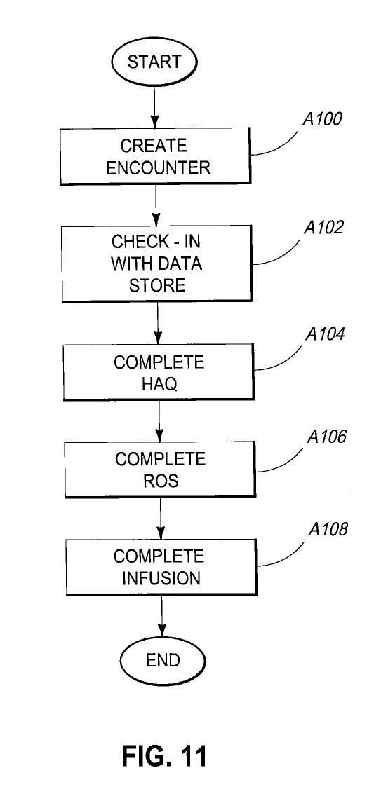

Referring to FIG. 11, one method of a patient check-in procedure is shown according to one embodiment when a patient is checking-in with a medical provider 102 for treatment during an encounter. The illustrated method may expedite the check-in process for medical providers 102. Other check-in methods may be used including more, less or alternative acts.

At an act A100, the patient appears at the front desk of the medical provider which may then create an encounter for the patient with a patient identifier for the patient. In one embodiment, the encounter is created using the EMR system 110 of the medical provider 102 and which generates an encounter identifier. The patient may also provide any co-pay (e.g., using an MGMA card) and verify insurance information.

At an act A102, the patient may be directed from the front desk to a check-in coordinator with a terminal which accesses the management system 101. The management system 101 may provide patient identification information to the EMR system 110 which then provides the generated encounter identifier to the management system 101.

At an act A104, the terminal coupled with the management system 101 may display a web page served from the management system 101 and which requests information from the patient. For example, a HAQ template may be provided where the patient may enter the requested data, such as responses to the HAQ questions, into the management system 101 perhaps with the assistance of a medical assistant. The management system may map the entered data to the EMR system 110 in a record for the patient.

At an act A106, the terminal of the management system 101 may serve another web page requesting additional information from the patient. For example, a review of systems (ROS) template may be provided where the patient may enter the requested data into the management system 101. The management system may map the entered data to the EMR system 110 in a record for the patient.

At an act A108, the patient may answer any questions regarding their state or ability to have drugs administered during the encounter within the management system 101. The patient may be administered the drugs and the respective infusion data (e.g., drug, amounts, etc.) may be inputted into the management system 101. The answers regarding infusion and the infusion data may be communicated to the EMR system 110. Thereafter, the patient is ready to meet with additional personnel, such as the treating physician.

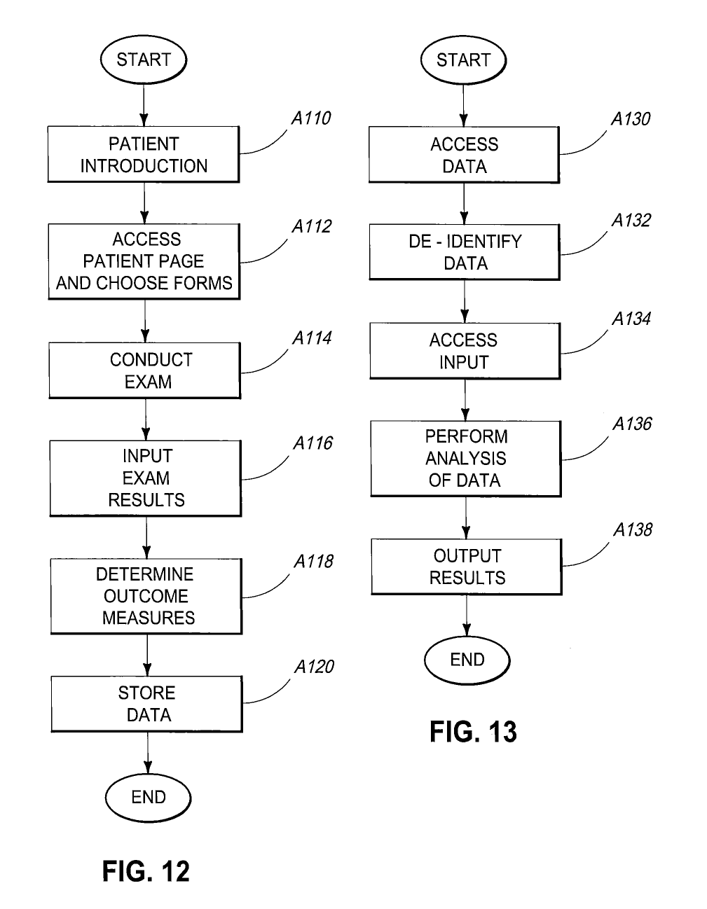

FIG. 12 is a flow chart of an examination of a patient by a physician according to one embodiment. Other methods may be used including more, less or alternative acts.

At an act A110, the physician and patient are introduced if it is the first visit of the patient or reacquainted if a returning patient. The physician and patient may discuss medical topics regarding the patient (e.g., other existing medical diseases or conditions, changes in the patient since the last encounter, medical history, etc.). Appropriate information may be entered into a webpage served from data store 104.

At an act A112, the physician may access the data inputted during the check-in procedure by the patient (e.g., HAQ, ROS, BASDAI, BASFI, infusion data) using an appropriate terminal 114 and accessing a web page for the patient served by the data store 104 in one embodiment. The physician may also review other pertinent information, such as disease trends and information from previous encounters. The physician may also review the patient's information prior to the introduction. In addition, appropriate templates or interfaces (e.g., interface FIG. 3) served from the data store 104 may also be accessed by the physician.

At an act A114, the physician conducts the examination including checking joints of the patient, range of motion, noting other symptoms or ailments, determining appropriate diagnoses, and conducting any other desired examinations or tests based upon the interaction with the patient. Examinations for medical conditions other than rheumatoid arthritis may include different procedures.

At an act A116, the physician uses a terminal to input the results of the examination. In one embodiment, the templates and interfaces of web pages served from management system 101 may be used for the data entry and to assist the physician. For example, the physician may input outcomes such as information regarding the conditions of the joints of the patient using the interface of FIG. 3 in one embodiment, VAS, results of range of motion tests, any other diseases the patient may have, and other pertinent medical information regarding the patient. The physician may also enter information regarding prescribed medicines. A medical assistant or other appropriate party may also input laboratory results into the management system 101. A chart note may be generated by the management system 110 and communicated to the appropriate medical provider 102. In addition, the inputted data may be mapped to the EMR system 110 of the appropriate medical provider 102.

At an act A118, pertinent outcome measures (e.g., DAS28) may be calculated using the inputted data in the management system 101.

At an act A120, the outcome measure may be saved in database 122 and communicated to the medical provider 102 as a chart note for entry into the EMR system 110 or a paper-based system maintained by the medical provider 102. The data resulting from the encounter may also be directly entered by system 101 into tables of the records maintained in the EMR system 110 in one embodiment. Thereafter, the updated information (e.g., trend information) and any previously stored data may be provided when forms or templates of the patient, such as the interface of FIG. 3, are accessed.

As mentioned above, the management system 101 may process patient treatment data and one example method is described with respect to FIG. 13. Other data processing methods may be used including more, less or alternative acts.

At an act A130, the web server 120 of the data store 104 accesses the patient treatment data and prepares the data for communication to data warehouse 106.

At an act A132, the patient treatment data may be de-identified during communication to the data warehouse. In one embodiment, the data within the birthdate and name fields of the record of the patient are not copied from database 122 of the data store 104 to the database 132 of the data warehouse 106 resulting in anonymous patient treatment data stripped of identification data which identifies the specific patient associated with the data.

At an act A134, the anonymous patient data is accessed by the data warehouse 106.

At an act A136, the anonymous patient treatment data is processed in an attempt to identify useful information with respect to future treatment of the common medical condition. For example, an appropriate algorithm or search criteria may be used to process the anonymous patient treatment data to perform appropriate data mining, statistical analysis, specialized searches according to a physician's terms, or other desired data processing. For example, new procedures for treating patients with the common medical condition may be developed or previously unknown trends in the previous treatment of the common medical condition may result from the processing of the data of the patients who have the common medical condition (e.g., an example procedure is applying a certain drug to individuals who have the common medical condition and a combination of additional common different characteristics as indicated by the processing of the patient treatment data of similar patients with the common medical condition and the combination of additional common different characteristics who responded well to the drug).

For example, as described above with respect to FIGS. 3A-3C, information for one or more outcomes may be provided for a given patient. Accordingly, information regarding the outcomes for respective patients is known. Furthermore, information regarding medications taken by previously-treated patients and results of the treatment of the diseases (e.g., disease progression or regression over time) may also be provided as discussed above. The information regarding the outcomes, medications, and disease progression or regression may be stored in management system 101 and subsequently processed to provide previously unknown information regarding the treatment of the diseases, or provide guidance in treatment of patients who have outcomes similar to previously-treated patients.

Patient treatment data including information regarding outcomes may be useful in a plurality of different ways. In one example, the outcome information may be useful for patient sub-group stratification where sub-groups of patients having common outcomes for a given a disease may be identified. In one more specific example, a plurality of sub-groups of patients may be defined where each of the sub-groups may include patients having common outcomes. Thereafter, a new patient having the same or similar outcomes of one the sub-groups may need treatment for the disease and the patient treatment data for patients of the one of the sub-groups may be beneficial in determining the future treatment of the new patient for the disease.

More specifically, the patients of a given sub-group (i.e., patients having the same or similar outcomes) may have been previously treated for a disease using various treatments (e.g., different medicines or combination of medicines). The patient treatment data including information regarding the progression or regression of the disease with the previous treatments of the patients of the sub-group may be useful to select the appropriate treatment(s) for future treatment of new patients whose outcomes correspond to the outcomes of the respective sub-group and based upon the effectiveness of the treatments for the previously-treated patients (i.e., a specific medicine or group of medicines which provided the most regression of the disease for previously-treated patients of the sub-group may be identified for treatment of the new patient having similar or the same outcomes as the patients of the sub-group).

In another example, patient treatment data of patients of a sub-group may also be analyzed over time to provide information regarding disease progression or regression resulting from the different treatments of patients of the sub-group over time. The best treatments (e.g., most effective treatments for disease regression) for different sub-groups may be used to develop protocols or pathways for treating future patients having outcomes which correspond to the outcomes of the different sub-groups. The number of possible sub-group combinations grows exponentially with the number of outcomes.

In one specific example, a given patient may be admitted for treatment for a disease, such as rheumatoid arthritis. The patient may be initially examined to determine the outcomes present for the respective patient, for example, using interface 30a of FIG. 3A. Following entry of the data indicating the outcomes for the respective patient, patient treatment data of the management system 101 may be used to help determine the appropriate future treatment of the patient. In one example, stored data of the management system 101 may be searched to locate a sub-group of one or more other patients having outcomes which correspond to the outcomes for the patient being treated. Once a sub-group of other patients is identified (the actual identities of the patients of the sub-group remain anonymous in at least one implementation), the respective patient treatment data of the group may be processed. For example, one or more medications which provided the best results or greatest effectiveness (e.g., most disease regression) in treating the other patients of the identified sub-group and having the similar or same outcomes may be used to treat the new patient.

In some implementations, a new patient to be treated may have outcomes which readily match a predefined pattern of outcomes in the patient treatment data of other patients corresponding to a defined sub-group, and the corresponding recommended treatment for the predefined pattern of outcomes for the sub-group may be known and used to treat the new patient. In other implementations, a new patient may have a unique combination of outcomes, and the patient treatment data may be processed in an attempt to identify the closest sub-group to which the new patient belongs, and thereafter, use the best treatment for the identified sub-group for recommendations on future treatment for the new patient.

At an act A138, the results of the data processing may be outputted. For example, the results of the processing may be provided to the participating medical providers 102, medical supply entities, government agencies, etc. The output may be electronic charts, numbers, graphs, figures, or tables via websites, email, pivot tables or paper documents in illustrative examples.

The medical information system 100 may also associate cost information of patient treatment with the patient treatment data. For example, costs of the medical treatment may be monitored by the providers 102 and included in patient treatment data and associated with a patient's medical record within EMR system 110 and management system 101. As mentioned above in one embodiment, a patient may utilize a health access card to pay for medical services (e.g., co-pay, insurance deficiencies, drugs, lab work, etc.). The cost information may also be obtained in any appropriate way, for example, from the accounting records of the patients in the medical providers 102.

Data regarding these costs may be received and stored in the databases of EMR system 110, data store 102, and data warehouse 106. The cost information for a respective patient may be included within their patient treatment data and may be useful for monitoring treatment over the history of the patient from a cost perspective as well as efficacy perspective. Data store 104 and/or data warehouse 106 may generate reports regarding patient treatment as well as the associated costs to justify or validate the efficacy of the medical care of a patient and perhaps be forwarded to government agencies (e.g., Medicare).

In one arrangement, the cost data may be shown on an encounter basis as well as a total history of medical treatment basis for a given patient (or other desired granularity) and may be associated with the specific treatment, drugs, implants, lab tests, medical procedures performed, etc. or the entirety of the treatment for a given patient. The cost information may also be utilized during processing of the data (e.g., data-mining, statistical analysis) to determine best medical practice procedures or other desirable uses in one embodiment.

Although aspects of the present disclosure may be utilized to record information regarding patients having various diseases or conditions, some of the aspects of the disclosure are discussed above with respect to rheumatoid arthritis. Compiled information regarding different conditions of different joints of the body is helpful in determining the extent of the disease in a patient being treated as well as ascertaining the patient's response to different treatments over time and may be a useful tool for formulating future treatments.

Rheumatoid arthritis is one of the most frequent potentially crippling joint diseases followed by rheumatologists-arthritis specialists. Fortunately, there have been relatively recent major changes in the therapeutic approaches as well as therapeutic options available for treatment of rheumatoid arthritis which have provided improved results for treating rheumatoid arthritis. For example, the increasing use of immunosuppressive agents (methotrexate, leflunomide, azathioprine) and subsequent development of biotech medications (TNF inhibitors, Orencia, Rituxan) have clearly changed the rates of progressive joint damage, deformity, and functional capacity and increased the life expectancy of patients who have rheumatoid arthritis.

However, these medications have significant toxicity, and the bioactive medications are extremely expensive drugs. Even in the best outcome trials, a high-grade response to any medication is seen in less than approximately 50% of patients. Accordingly, major issues in treatment remain of how to best follow patients and make decisions about when they are doing well or poorly and at what point changes in drug therapies between the available agents should be made.

As discussed above, various information may be used by medical personnel to treat patients. Physician visual analog scales (VAS) of estimated active joint inflammation, laboratory measurements of inflammation (ESR) and measures of patient's physical function scores (health assessment questionnaire-HAQ scores) are used to attempt to detect changes in joint inflammation/disease activity over time. The pooling of this information is important since all of these factors are valuable in follow-up of groups of patients. Furthermore, the provision of this information may be important for treatment of individual patients who may have isolated features that are indicative of their disease evolution. At least some aspects of the disclosure enable efficient recordation, generation and maintenance of the information for efficient recollection, compilation, use and review by medical personnel.

More recently, the above-described composite outcome measure scoring system DAS28 has been utilized which combines mathematically weighted variables discussed above including swollen and tender joint scores, general health estimates of disease activity by the physician, and laboratory measure of inflammation (ESR). At least some aspects of the disclosure described above enable treating physicians to efficiently input information pertinent to the composite outcome measure scoring system and the computing system 10 may automatically calculate the outcome measure scores and provide different representations of the scores and associated data, for example, by graphing and including trend information of scores over time.

DAS28 scores have been shown to correlate well with medication responses in trials and this measurement system is increasingly used in clinical trials worldwide and clinics have been gradually adopting daily use of these measurements in outpatient settings in an attempt to attach numerical scores to disease activity and use of these scores to “drive” changes in therapy. The described example DAS28 scoring system is useful for detecting change in joint inflammation and at least some aspects of the disclosure facilitate analysis of DAS28 scores and tracking of disease activity over time, for example by providing trend data of DAS28 scores indicative of a patient's activity over time. At least some aspects of the disclosure provide improvements of recording and providing trend data regarding plural examinations of a patient compared with typical day-to-day clinical examinations where joint examinations are performed but clinicians rarely go back over time to see if there are significant progressive changes in various parameters being monitored.

At least some aspects of the disclosure facilitate electronic capture of information regarding swollen and tender joints that indicate joint disease activity and potential for progressive joint damage, along with data regarding joints that are becoming more restricted or deformed. This electronic information may be easily provided into understandable tables and graphs and other representations for use by medical personnel and which may also be easily stored and tracked over time. The ability to quickly and easily record information regarding joint tenderness, swelling, deformity and range of loss enable presentation of the information in different formats and templates which is extremely helpful in a real-life clinical situations and enables medical personnel to easily assess current disease activity and recent progression in joint damage/function as well as identify more subtle changes which can be tracked over time. By the end of a clinical exam, a clinician can immediately assess information regarding progression of active or deforming/limiting joint disease.

As mentioned above, current medications used to slow or stop progression of rheumatoid arthritis have significant toxicity and increasingly very high cost. Accordingly, it is important to use these medications in the best possible way for patient care and also to quickly recognize if expensive and somewhat risky drug therapies are not providing sufficient benefit and should be stopped. It is believed that the ease of inputting, recording and reporting of patient's information provided by aspects of the present disclosure provide an efficient tool for use by medical personnel to treat diseases, including rheumatoid arthritis. It is believed that aspects of the present disclosure which facilitate the recording of patient's information and the efficient provision of the information into one or more desired format are of increased importance in the era of “evidence based medicine” where both patients and insurers want both the best and most cost efficient management of disease. The generated reports can be used to determine whether patients are responding favorably to treatment (e.g., medicates) or whether the treatment should be changed. The reports may be used to justify costs for treatment in some examples by efficiently providing data in a format which indicates the patient's responses to treatment.

It is believed that the disclosed example aspects of capturing, generating and recording electronic data can allow the real life clinician to have easy and time efficient access to information which is vital for treatment of disease. Although aspects of the disclosure are described with respect to rheumatoid arthritis, the disclosed aspects are applicable to treatment of other diseases and other health conditions, especially chronic diseases with relatively long-term poor outcomes where tracking of a mix of clinical, laboratory and patient functional data can allow more optimal medical decision making. At least some aspects of the disclosure bring measurement parameters laboriously used in clinical trials to a level that can be efficiently applied to daily clinical patient management and treatment in one embodiment.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended aspects appropriately interpreted in accordance with the doctrine of equivalents.

Further, aspects herein have been presented for guidance in construction and/or operation of illustrative embodiments of the disclosure. Applicant(s) hereof consider these described illustrative embodiments to also include, disclose and describe further inventive aspects in addition to those explicitly disclosed. For example, the additional inventive aspects may include less, more and/or alternative features than those described in the illustrative embodiments. In more specific examples, Applicants consider the disclosure to include, disclose and describe methods which include less, more and/or alternative steps than those methods explicitly disclosed as well as apparatus which includes less, more and/or alternative structure than the explicitly disclosed structure.

What is claimed is:

1. A medical information system comprising:
a communications interface which is configured to receive patient treatment data from a plurality of medical providers and which regards medical treatment provided by the medical providers with respect to a plurality of patients; and
storage circuitry storing the patient treatment data for the plurality of patients of the plurality of the medical providers in a database.

2. The medical information system of claim 1 wherein the patient treatment data includes identification information which identifies the patients.

3. The medical information system of claim 1 further comprising processing circuitry configured to access a request for the patient treatment data for an individual one of the patients from one of the medical providers providing medical care to the individual patient during an encounter with the one medical provider, and to output the patient treatment data for the individual patient to the one medical provider as a result of the accessing of the request.

4. The medical information system of claim 3 wherein the processing circuitry is configured to receive updated patient treatment data from the one medical provider for the individual patient as a result of the encounter, to update a medical record of the individual patient in the database using the updated patient treatment data, and to control communication of the updated patient treatment data to the one medical provider.

5. The medical information system of claim 4 wherein the processing circuitry is configured to control the communication of the updated treatment data as a chart note to the one medical provider.

6. The medical information system of claim 4 wherein the processing circuitry is configured to control the communication of the updated treatment data as an update to a medical record of the individual patient in an electronic medical record system of the one medical provider.

7. The medical information system of claim 1 wherein the patient treatment data comprises anonymous patent treatment data without identification information which identifies the patients.

8. The medical information system of claim 1 wherein the patients have a common medical condition, and further comprising processing circuitry configured to process the patient treatment data to identify useful information with respect to future treatment of the common medical condition.

9. The medical information system of claim 1 wherein the patients have a common medical condition, and further comprising processing circuitry configured to process the patient treatment data to identify new procedures for treating the common medical condition.

10. The medical information system of claim 1 wherein the patients have a common medical condition, and further comprising processing circuitry configured to process the patient treatment data to attempt to identify previously unknown trends with respect to the treatment of the common medical condition.

11. The medical information system of claim 1 further comprising processing circuitry configured to control the communications interface to communicate the patient treatment data to medical supply entities in exchange for compensation for the medical providers.

12. The medical information system of claim 1 wherein the patient treatment data includes outcome measures indicative of the treatment of the patients, and further comprising processing circuitry configured to process the patient treatment data to provide outcome based medical treatment information.

13. The medical information system of claim 1 wherein the patient treatment data includes outcome measures indicative of the treatment of the patients, and further comprising processing circuitry configured to process the patient treatment data to provide efficacy information regarding the treatment of the patients.

14. The medical information system of claim 1 wherein the patient treatment data comprises cost information regarding the medical treatment provided by the medical providers with respect to the plurality of patients.

15. The medical information system of claim 14 further comprising processing circuitry configured to associate the cost information for an individual patient with the patient treatment data provided by one of the medical providers which provided the medical treatment to the individual patient.

16. The medical information system of claim 1 further comprising processing circuitry at one of the medical providers configured to display a graphical representation of human anatomy and at least some of the patient treatment data is inputted by interaction of medical personnel with the graphical representation of human anatomy.

17. The medical information system of claim 16 wherein the processing circuitry is configured to access the graphical representation of human anatomy from an entity which also operates the communications interface and the storage circuitry.

18. A medical data processing method comprising:
receiving patient treatment data regarding medical treatment provided by a plurality of medical providers to a plurality of patients;
de-identifying the patient treatment data comprising removing identification information from the patient treatment data which identifies the patients and providing anonymous patient treatment data void of the identification information; and
permitting access of medical supply entities of medical products which are used during the medical treatment of the patients to the anonymous patient treatment data.

19. The method of claim 18 wherein the patient treatment data is with respect to the patients who have a common medical condition.

20. A medical data processing method comprising:
using processing circuitry, accessing patient treatment data regarding medical treatment provided by a plurality of medical providers to a plurality of patients having a common medical condition; and
using processing circuitry, processing the patient treatment data to identify previously unknown information with respect to treatment of the common medical condition.

21. The method of claim 20 wherein the processing comprises processing to identify new procedures for treating the common medical condition.

22. The method of claim 20 wherein the processing comprises processing to identify previously unknown trends in the patient treatment data useful to future treatment of the common medical condition.

23. The method of claim 20 wherein the processing comprises applying a data processing algorithm to the patient treatment data.

24. The method of claim 20 wherein the accessing comprises accessing information regarding outcomes of the patients and different medications used by the patients, and the processing comprises comparing effectiveness of different ones of the medications with respect to treatment of the patients having a common outcome to identify the previously unknown information.

25. The method of claim 24 wherein the generated information identifies one of the medications as providing increased regression of the disease for the patients having the common outcome compared with another of the medications.

26. The method of claim 20 wherein the accessing comprises accessing information regarding outcomes of the patients and different medications used by the patients, and the processing comprises generating information regarding disease progression or regression over time with respect to different medications used by different ones of the patients having a common outcome to identify the previously unknown information.

27. The method of claim 26 wherein the generated information identifies one of the medications as providing increased regression of the disease for the patients having the common outcome compared with another of the medications.

28. A medical data processing method comprising:
using processing circuitry, accessing patient treatment data regarding medical treatment provided by a plurality of medical providers to a plurality of patients having a common medical condition; and
using the patient treatment data to demonstrate efficacy of the medical treatment provided by the medical providers to the patients to treat the common medical condition.

29. The method of claim 28 wherein the accessing comprises accessing outcome measures regarding the medical treatment and the using comprises using the outcome measures to support the efficacy of the medical treatment.

30. The method of claim 28 wherein the accessing comprises accessing cost information regarding the medical treatment and the using comprises using the cost information to support the efficacy of the medical treatment.

31. A medical data processing method comprising:
using processing circuitry, accessing information regarding a patient having a medical condition which is to be treated, wherein the accessed information includes information regarding a plurality of outcomes for the patient which correspond to the medical condition; and
using processing circuitry and the information regarding the plurality of outcomes, identifying an appropriate treatment for the patient using information regarding the previous use of the treatment upon a plurality of other patients with the medical condition and whose outcomes correspond to the outcomes of the patient.

32. The method of claim 31 wherein the identifying an appropriate treatment for the patient comprises selecting a medicine for use by the patient having the medical condition which is to be treated.

33. The method of claim 32 wherein the selecting the medicine comprises selecting the medicine as a result of the medicine having the greatest effectiveness to treat the other patients with the medical condition and whose outcomes correspond to the outcomes of the patient.
